(19) United States
(12) Patent Application Publication
(10) Pub. No.: US 2015/0032366 A1
(43) Pub. Date: Jan. 29, 2015

(54) SYSTEMS AND METHODS FOR DELIVERING HIGH RELEVANT TRAVEL RELATED CONTENT TO MOBILE DEVICES

(71) Applicants: Matthew Lai Him Man, Thornhill (CA); Rishi Khanna, Mississauga (CA)

(72) Inventors: Matthew Lai Him Man, Thornhill (CA); Rishi Khanna, Mississauga (CA)

(21) Appl. No.: 14/008,119

(22) PCT Filed: Mar. 15, 2013
(86) PCT No.: PCT/CA2013/000255

§ 371 Date: Sep. 27, 2013

Related U.S. Application Data
(60) Provisional application No. 61/611,807, filed on Mar. 16, 2012.
(60) Provisional application No. 61/716,798, filed on Oct. 22, 2012.

(51) Int. Cl. G08G 1/0967; G08G 1/0968; H04W 4/04

(52) U.S. Cl. CPC G08G 1/096741; H04W 4/046; G08G 1/096844; G08G 1/096872
USPC 701/412; 701/451; 701/414

(57) ABSTRACT

A mobile computing implemented platform is provided that enables the generation, and delivery of highly relevant content to the mobile device of a driver. The content is filtered based on the current location and direction of the driver, and content is generated and filtered based a crowd sourced model where a plurality of users who are driving within a similar locations are linked to one another via the platform for improved discovery of traffic conditions, and improved determination of user interest based on collective interest of the plurality of users. Various intelligent features are enabled by the platform.

### CROSS REFERENCE TO RELATED APPLICATIONS

This application claims all benefit, including priority, of each of U.S. Provisional Patent Application Ser. No. 61/611,807, filed Mar. 16, 2012, entitled SYSTEMS AND METHODS FOR DELIVERING HIGH RELEVANT TRAVEL RELATED CONTENT TO MOBILE DEVICES; and U.S. Provisional Patent Application Ser. No. 61/716,798, filed Oct. 22, 2012, entitled SYSTEMS AND METHODS FOR DELIVERING HIGH RELEVANT TRAVEL RELATED CONTENT TO MOBILE DEVICES, the entire contents of each are incorporated herein by this reference.

### FIELD OF THE INVENTION

The present invention relates generally to mobile technologies. The present invention further relates to methods and systems for managing traffic, and sending contextual audio and visual messages to a traveler.

### BACKGROUND OF THE INVENTION

Vehicle commute times are increasing. Traffic in many urban communities is getting worse, and traffic patterns in many locations are increasingly unpredictable. Various technologies and services are known for delivering traffic information, however, generally these solutions are not sufficiently localized. For example, radio traffic reports do not provide coverage for all locations. Drivers listening to radio traffic reports are required to listen to significant traffic information that does not relate to them in the hope that eventually relevant traffic information will be provided. There is a need for a traffic information source that is more localized.

In addition, to maintain safety there is a need to avoid unnecessary distraction of drivers. As result there is a need to provide a platform that is operable to filter information such as traffic information, so that only the most relevant information is pushed to a driver's mobile device.

### SUMMARY OF THE INVENTION

In accordance with an aspect of the present invention there is provided a method, performed by one of a mobile device and a computer server, the mobile device associated with a transportation vehicle and in communication with the computer server over a communications network, comprising: acquiring location information of the transportation vehicle; receiving current route information associated with the transportation vehicle; determining at least one route segment associated with the current route information; determining a travel direction of the transportation vehicle; determining a current route segment of the transportation vehicle from the determined at least one route segment associated with the current route information; updating a user profile with at least one information element based at least partly on the determined travel direction and the current route segment, the user profile associated with the transportation vehicle; filtering the at least one information element by performing at least one analytical operation on the user profile; and providing an indication of at least one of the filtered information elements at the mobile device.

In accordance with other aspects of the present invention there is provided a non-transitory computer program product tangibly embodying code that, when executed by a processor, causes the processor to carry out the method of the present invention.

In accordance with another aspect of the present invention there is provided a system comprising a mobile device and a computer server, the mobile device associated with a transportation vehicle and in communication with the computer server over a communications network, one of the mobile device and the computer server being configured to: acquire location information of the transportation vehicle; receive current route information associated with the transportation vehicle; determine at least one route segment associated with the current route information; determine a travel direction of the transportation vehicle; determine a current route segment of the transportation vehicle from the determined at least one route segment associated with the current route information; update a user profile with at least one information element based at least partly on the determined travel direction and the current route segment, the user profile associated with the transportation vehicle; filter the at least one information element by performing at least one analytical operation on the user profile; and provide an indication of at least one of the filtered information elements at the mobile device.

In other aspects of the present invention, there is provided a method of generating information relevant to a driver of a vehicle is provided, and delivering this information to the driver in a safe and useful manner, the method comprising the steps of:
(a) opening a client computer program, implemented as a mobile client computer program loaded on a mobile device; the mobile client computer program being linked to a computer server implemented server application (the mobile client computer program and/or the server application being the “content service”);
(b) obtaining location information for the driver;
(c) the driver selecting current route information, or entering an origination and/or a destination or the content service inferring current route information;
(d) the content service accessing or determining for the route one or more route segments;
(e) the content service optionally accessing various route options for the users to go from the current location to the destination (the route options being provided explicitly or inferred);
(f) the content service presenting the routing options to the driver, and also displaying any major incidents along the way;
(g) the content service obtaining information regarding the driver's current route segment, and the driver's direction; and
(h) the content service determining a set of information elements relevant to the driver, the content service then filtering the information elements for relevance based on one or more analytical operations performed by the client service based on the profile;

In another aspect, the profile is based relevant information elements are filtered based on relevance of the information elements for a group of users that are currently at a similar location, as established by the content service.

In a still other aspect, the group of users are linked for the purpose of soliciting feedback regarding traffic conditions, and using this feedback to create traffic condition content and also to assist in filtering traffic condition content for relevance to the driver.

In another aspect, the users are prompted to, or decide to provide incident reports of a particular incident on the route that they are travelling, by touching a call to report traffic button or equivalent, or by issuing a voice command, or by touching specific buttons on the application pertaining to certain road conditions such as construction, accidents, or slow traffic. Optionally, the user can leave a voice message to the platform, which may be processed using a natural language traffic report interpretation utility.

In another aspect, the user hears curated and validated live user reports from a user ahead of them, in another aspect of the community building and social aspects of the platform. In one aspect of the invention, a first user's contributions to traffic reports are heard directly by other users behind the first user in the flow of traffic, in a route being travelled by each of the respective users.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 is a diagram illustrating a first possible implementation of the invention.

FIG. 1a illustrates a representation of a system, in one possible implementation of the invention.

FIGS. 2a to 2j illustrate various possible screens provisioned by the mobile application, in one possible implementation thereof.

FIG. 3 illustrates another possible system implementation.

FIGS. 4 and 5 illustrate client and server resources respectively, in accordance with implementations of the present invention.

FIG. 6 illustrates workflow diagram illustrating the voice search functionality of implementations of the present invention.

FIG. 7 illustrates a representative generic implementation of the invention.

FIG. 8 is a workflow diagram showing a possible implementation of the natural language traffic interpretation and validation utility in accordance with an aspect of the present invention.

### DETAILED DESCRIPTION

In various aspects, the disclosure provides a technology platform (“platform”) that enables the delivery of content to one or more mobile devices. In one aspect of the invention, the platform delivers content to the one or more mobile devices when the one or more mobile devices are in use in a vehicle.

In a particular aspect of the invention, the platform is operable to filter content so as to deliver only content that is highly relevant to users based on (a) location, and (b) user interest. The content includes traffic information and may also include for example advertising information, or other content that is relevant to user such as local weather condition and forecasts, local breaking news, and local gas prices.

In another aspect of the invention, the content is delivered in a manner to minimize distraction to drivers. In a particular aspect of the invention, the content is primarily voice data. Significantly, a number of the features are implemented using voice input and voice output so as to enable hands free access to at least some of the features described.

In an aspect of the invention, the disclosure provides methods performed by one of a mobile device and a computer server, the mobile device associated with a transportation vehicle and in communication with the computer server over a communications network, comprising: acquiring location information of the transportation vehicle; receiving current route information associated with the transportation vehicle; determining at least one route segment associated with the current route information; determining a travel direction of the transportation vehicle; determining a current route segment of the transportation vehicle from the determined at least one route segment associated with the current route information; updating a user profile with at least one information element based at least partly on the determined travel direction and the current route segment, the user profile associated with the transportation vehicle; filtering the at least one information element by performing at least one analytical operation on the user profile; and providing an indication of at least one of the filtered information elements at the mobile device.

In another aspect of the invention, the disclosure provides a non-transitory computer program product tangibly embodying code that, when executed by a processor, causes the processor to carry out the method of the present invention.

In another aspect of the invention, the disclosure provides systems comprising a mobile device and a computer server, the mobile device associated with a transportation vehicle and in communication with the computer server over a communications network, one of the mobile device and the computer server being configured to: acquire location information of the transportation vehicle; receive current route information associated with the transportation vehicle; determine at least one route segment associated with the current route information; determine a travel direction of the transportation vehicle; determine a current route segment of the transportation vehicle from the determined at least one route segment associated with the current route information; update a user profile with at least one information element based at least partly on the determined travel direction and the current route segment, the user profile associated with the transportation vehicle; filter the at least one information element by performing at least one analytical operation on the user profile; and provide an indication of at least one of the filtered information elements at the mobile device.

By improving relevance, the technology platform may provide significant advantages over the prior art. A number of such possible advantages are explained below.

Significantly, the platform includes one or more filters that are operable to filter the content to a group of users registered to the platform in a similar location, rather than filtering the content to a particular user only. For example, the content may be personalized for a group of users travelling on the same street, or travelling within the same section of a highway, or based on a user's interests (for example depending on whether a user is a coffee drinker or not). The use of a filtering engine that is non-personalized offers significant advantages in terms of the performance and scalability of the platform. In another possible aspect of the invention, these non-personalized offers may also be ‘cached’ and may be further localized or personalized for users, thereby making them actionable by users. The platform may use both user-generated data and traffic feeds to deliver content to mobile devices. In particular, the platform may include a natural language traffic report interpreter and other features to combine to generate an actionable traffic report for users. Examples of data usable by the platform include but are not limited to: (i) crowd-sourced traffic flow data with varied sampling frequencies; (ii) traffic incidents reported via voice and touch interface using a mobile device; (iii) traffic incident reports retrieved from another network source, including over the Internet; (iv) Government traffic feeds; and (v) third-party traffic sources. In possible non-limiting implementations of the invention, the platform may include a natural language traffic report interpreter effective for machine validation and human validation for exceptions. The platform may include some or all of the following non-limiting functionality: (i) alternative suggestions algorithm; (ii) dynamic travel time algorithm; (iii) real time personal traffic report composition adaptive based on user preference; (iv) audio and visual contextual traffic reporting; and (v) actionable traffic reports for users where users can react and choose different routing options based on a variety of factors, possibly including travel time and cost. The platform may further include staging functionality for further performance and scalability of the platform without the sacrifice of individual tailored information.

In another aspect of the invention, the platform is operable to personalize information (for example traffic information) based on a route that is determined for a particular user at a particular time. In one aspect, the platform is operable to determine the route that the user is travelling, based on the location of the user and the direction in which the user is travelling. The location and the user's direction enables the establishment of a personally relevant route.

An application may be installed on a mobile device, such as a mobile phone, that will send the current location and direction in which the mobile phone is heading to a centralized server. This direction will represent the direction of the car, as it is assumed that the mobile phone is with the driver in the car.

The centralized server sends back the traffic information around the neighbouring streets given the current location of the phone and filters out traffic and other traveller related information such as but not limited to community safety zones, red light camera locations, high crash intersections, information that is not relevant to the direction in which the mobile phone is heading. This traffic information may include but is not limited to the following: (i) location coordinates (longitudes and latitudes) of the start point and the end point (i.e. a road segment) in which the traffic conditions apply in the direction of the mobile phone and the car; (ii) the speed or colour coded representation of the speed representing the traffic condition; (iii) a sequence of voice files that corresponds to a voice announcement of such traffic reports; (iv) community safety zone messages, (v) red light camera locations, (vi) high crash site intersections, and (vii) relevant retail store offers and coupons.

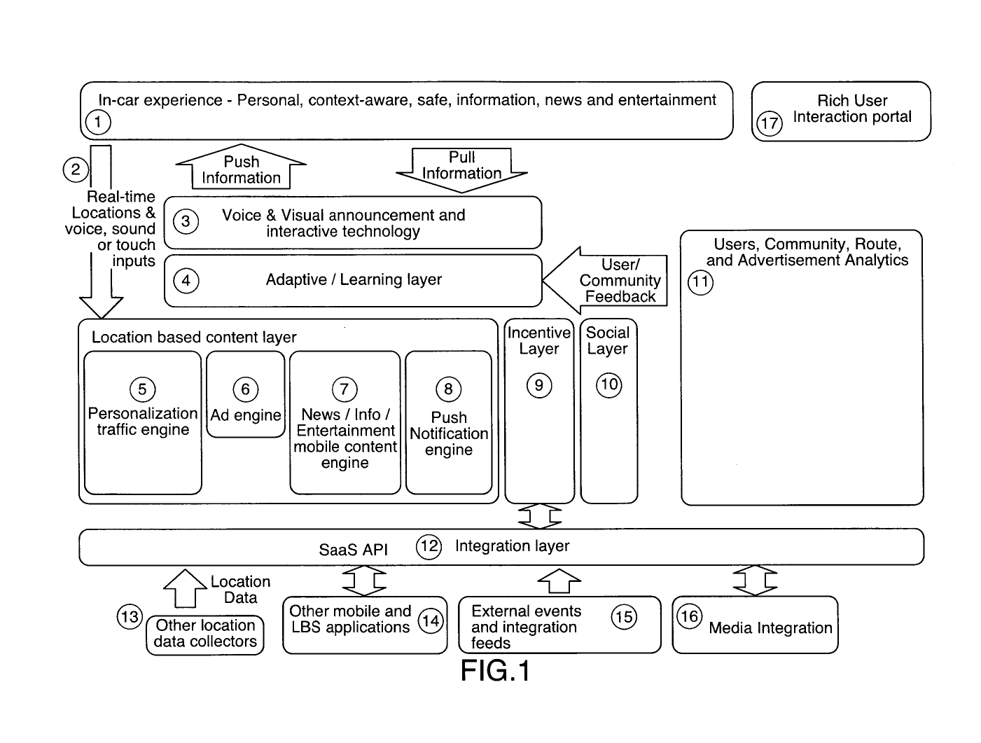

In one particular implementation of the invention, as shown in FIG. 1a, the platform consists of a server application (10), connected to a database (12), the server application (10) being implemented to one or more server computers (14), or may be implemented as an interconnected network of computer providing a cloud service. The platform further consists of a mobile application (16) which is linked to a suitable network connected device (18). The mobile application (16) interoperates with the server application (10) in order to deliver to users the functionality described.

In one implementation, the mobile application (16) consist of either a thick client or a thin client that relies on the server application (10) to enable the delivery of relevant content as described. It should be understood that the main functions of the mobile application (16) are to enable the delivery of selected content, including voice content, and also optionally the display of relevant visual information, as explained below. The mobile application (16) includes various features that are designed to deliver content (visually and audibly) in a way that minimizes distraction of the driver, and enables the consumption with relative safety while driving. A number of such features are described below.

It should be understood however that the present invention is not limited to particular distributions of the functionality as between the mobile device (20) and the server computer (14). For example, the mobile application (16) may be implemented in part as a mobile web application, with certain features that may be desirable as part of a thick client, being accessed from the mobile device (20) by accessing the server computer (14) which implements a mobile web server.

In one aspect of the invention, the mobile application (16) is operable to obtain its current location information (for example by accessing GPS functionality (19) of the mobile device (20)), and this information is sent to the server computer (14) by operation of a messaging system integrated with the mobile application (16) or by accessing a messaging system linked to the mobile device (20). The mobile application (16) is also operable to determine the location in which the vehicle of the user is travelling and this information is also sent to the server computer (14), by determining the direction in which the mobile device (20) is travelling (using for example built in accelerometers and the like that are built into the mobile device (20)). In one aspect of the invention, the direction in which the mobile device (20) is travelling is assumed to be the direction in which the vehicle is travelling, as it will be assumed that the mobile device (20) is with its owner if it is moving.

The server application (10) then links to the database (12). The database is configured to receive, for example from one or more data sources, traffic information, which traffic information is stored in the database so as to be associated with particular locations. The server application (10) and the database (12) are provided in a way that the server application (10) is operable to initiate a request to the database (12) to retrieve traffic information for a particular location, which in this step, in one implementation, is based on determining an area that may be within a threshold distance of the user's current location. Consequently, the database (12) may return traffic information that is relevant to the location generally of the user. The server application (10) then initiates a first set of filtering operations to filter out traffic information based on the direction that the vehicle is travelling. It should be understood that the prior art technologies include all traffic information, this results in presentation of additional information to for example mobile applications linked to a web application or online service, that is irrelevant to the user and therefore can be visually distracting from the information that the driver is trying to consume safely. The idea of determining direction of travel and using this to filter the information is in and of itself a novel and innovative platform feature that provides important advantages to users, and also the operator of the platform by driving user adoption, and satisfaction with the platform.

In one aspect of the invention, the traffic information provided by the server application (10) for delivery to users via the mobile application (16) includes: traffic information around the neighbouring streets given the current location of the mobile device (20), but filtering out traffic information that is not relevant to the direction in which the mobile device (20) is heading. This traffic information contains but not limited to the following: (A) location coordinates (longitudes and latitudes) of the start point and the end point (i.e. a road segment) in which the traffic conditions apply based on the travel direction; (B) instructions for displaying traffic information such as traffic condition severity levels, which upon receipt the mobile application (16) is configured to use to display information on a map view that includes speed or colour representations or other visual indicators of the the current traffic condition; and (C) a sequence of voice files that corresponds to one or more voice announcements related to traffic information.

Obtaining an accurate location from GPS technology can sometimes be challenging, especially in particular locations where obtaining location information using GPS is less accurate than may be desired. In one aspect of the invention, the server application (10) includes a localization utility (22) that is operable to apply one or more operations for confirming or improving the accuracy of an initial current location obtained using GPS. In one particular aspect of the technology, the localization utility (22) implements one or more operations or algorithms that are adapted to enable confirmation that the correct travel path has been determined. In one particular aspect a predictive algorithm (26) may be used to enable this confirmation. The predictive algorithm, in one implementation, looks at the possible turns and paths available based the road network topology, and make a best-scoring determination as to the where the location of the mobile device is heading based on all current available options, previous route trajectory and other profile related factors, and applies one or more weighting operations to establish a prediction of an optimal or close to optimal travel path outcome.

In another aspect of implementation of the invention, the mobile device (20) receives the traffic information described from the server computer (14) and is applicable to process the information so as to present the traffic information on one or more screens of the mobile application (16). This includes drawing coloured lines on top of the corresponding road segments with an arrow pointing to the direction of the traffic flow, so as to indicate traffic flow and speed information. The color of the lines will represent the speed of the street segment in. The display of the direction in which the driver is travelling is important as it eliminates confusion and removes the additional mental processing that is required by prior art platforms in order to enable users to interpret the display traffic information, which given that users must focus on driving improves safety and reduces frustration of users. The display of the direction information significantly reduces the time that the average driver requires to look at the display of the mobile device (20) in order to obtain traffic information that is relevant to them.

The sequence of voice files may be accessed by the mobile application (16) and presented to the user. The voice files may confirm audibly the same traffic information indicated on the screen, and also optionally additional information such as voice reports explaining the traffic information or providing further information that may be further along an assumed route determined by the server application (10). For example the voice reports may include traffic incident reports, but relevant only to the route that the user is travelling.

In another aspect of the invention, the adaptive layer of the present invention may also voice out other traffic incident reports ahead of the user based on the routes the users had driven in the past, as well as routes for users having the same or similar driving profile. This may result for example in the user receiving from the system additional alerts affecting streets that are connecting to the user's current street, such as an exit of a highway to an arterial road. The system may determine based on driving patterns of the user, or that of other users with a similar driving profile that incident reports regarding the arterial road may be of interest to the user travelling on the highway.

It is important to note, that in one aspect of the invention, the platform may suggest alternate routes, based on voice commands and also based on the visual display, for example by indicating a flashing arrow pointing away from the current travel path. Alternate routes may also be based on for example a significant change in the travel time to destination estimate, or a detection of an incident, a change in road conditions, or a major slow down on the user's route. Upon such events, the platform may automatically calculate if there is a faster route to the destination before prompting the user to determine whether they are seeking a faster route. This implementation sequence allows the platform to be very responsive to the user's prompt, as the result of the suggested alternative is already calculated and stored to the platform. A skilled reader will appreciate that it is it is advantageous that the system is perceived as being very responsive to users, especially while they are driving, and users have little time or attention to wait for a response from the system.

In another aspect of the invention, the platform determines the road that the user is travelling on, and the direction in which the user is travelling. The platform then checks the traffic conditions ahead of the user's location on the road as well as all the relevant traffic conditions on intersecting streets, or other relevant traffic conditions as determined based on one or more adaptive operations that are implemented to the server application (10). The server application (10) includes a profile manager (24) that is operable to build a profile for each user, in part by logging their travel information to established common routes, for example at particular days/times. The profile may be used to support the adaptive/predictive operations mentioned above. For example, the profile manager (24) is operable over time to establish a series of preferred routes for each user. The profile may also be used to tailor the estimated time of arrival to a destination based on the user's driving habits. A skilled reader will understand that in one aspect the present invention enables the generation of a more accurate travel time estimate. The system of the present invention, in one aspect, may use feedback from the user regarding the actual time that it took to drive from the same destination or origination, to adjust and adapt the travel time estimate should the same user or a similar user request the same destination. Other factors such as, but not limited to, time of day, weather conditions, and road conditions may also be stored for future travel time estimation. The actual travel time of the particular user may also be categorized as faster, normal or slower driver than the ‘norm’. This user profile information may be used to present travel time of other origination and destination requests as the user is likely to be consistent in being faster or slower in comparison to “normal” travel time. As a result, the travel time would be personalized, including based on the relevance of the user's personal driving habits.

A skilled reader will understand that travel time calculated in accordance with the present invention is a travel time that is more relevant to users as it considers their driving habits, weather conditions, road conditions. In contrast, prior art methods are mainly based on distance, and traffic condition, which provides a less accurate travel estimates.

A skilled reader will also appreciate that the present invention utilizes road and weather conditions in a unique and innovative manner. In one aspect of the invention, the system is operable to capture road and weather conditions, and traffic conditions that are further ahead on a road segment being traveled by a user. Prior art systems typically consider the close vicinity of a driver, and therefore conditions in the region that the driver will soon reach if the continue along their current path.

Prior art systems that are highly dependent on traffic conditions tend to be less accurate because by the time a user arrives at a next segment the traffic conditions may have changed. Road surface conditions or weather conditions in contrast may however enable more accurate prediction of travel estimates.

### Automatic Extension of Area of Impact Due to an Incident

It is important to note that prior art traffic detection technology often relies only on the sensor or the car that has been stuck/slowed down in the area of an incident, and detects the effect of such slow down. However, this method generally requires a car to fully tranverse the slow down area in order for the traffic sensor to enable the capture of speed information for the relevant area. However, in other times, where an accident may have just happened and user made a report regarding the accident, the extent of the resulting backlog may not be known. The contribution of the present invention includes (1) assigning a profile to traffic slow down areas based on heuristics rules as well as adaptive weighting based on similar incidents occurred in the past, and (2) deducing the extent of an accident the incident location and the users/cars that have started to slow down upstream. Therefore, the impact of the incident can be detected faster than using traditional methods and can often be immediately detected and correlated back to the incident down stream without the need for the user having to travel all the way to the incident location before the full effect is detected. This advancement in knowing the impact of incident will also help increase the accuracy of the travel time estimation in accordance with the present invention and thereby provide better route alternatives for other users who may plan to use the same road segment affected.

The user may also be invited to provide further information related to preferred routes and other matters, for example by operation of a settings utility. This may also include from time to time sending a message to the user. For example when it is detected that the mobile device (20) is not moving in a way that suggests that the user is driving, a request may be sent to the user to confirm that certain routes are preferred routes. This confirmation inquiry can also be used to confirm if the user is on a particular lane of interest, such a High Occupancy Lane (HOV) or more commonly know as a Carpool lane.

### Support of Road Closure for Providing Route Suggestions

Many prior art routing algorithms only use road network geometry and travel speed information or time of each segment, to provide a optimal route from origination to destination. They often do not take into account road closed conditions, up-to-date road construction information, accident information (i.e. media information in general) when recommending a route. The platform of the present invention permits evaluation of a recommended route for example based on road closure information, in which case the system would not recommend such route. Optionally, the system may provide an explanation as to why a particular route is not recommended. In another aspect, the system may show different route recommendations, each recommendation may be provided a rating, and the system provides a plurality of recommendations, each recommendation having a rating and an explanation of that rank. In yet another implementation the system displays recommended routes placed in order of their rating.

The profile manager (24) is accessed by the server application (10) in order to filter traffic information to relate to the current road or highway segment, and direction, in which the user is travelling but also the probably next road segments where the user is likely to be headed based on the preferred routes. In one aspect of the invention, traffic information for next road segments may only be delivered once one or more threshold values are met for determining likelihood that in fact next road segments represent where the user intends to travel. In this way the platform is able to predict where the user is headed, and may provide certain traffic information that enables the user to modify their route before it is too late, for example because they are now stuck in slow traffic and a good viable route may now have been missed.

In another aspect of the invention, the system incorporates functionality that is operable to detect a lane based trajectory of a user's path, which represents a significant advance over the prior art. The GPS accuracy of current smart phones is in the range of 2-5 meters, whereas the width of most road lanes is 3.5 meters. This raised a challenge of how we can detect if a user is on a particular lane, as the position of the mobile device within the car (to the left passenger side or the right passenger side) may itself make a difference. In one aspect of the present invention, a a series of GPS location samples are captured and arranged to form a trajectory line, one or more trajectory lines are compared against the centerline of the lane (such as an HOV lane) using angle alignments. Especially for an HOV lane, speed may be used in comparison to speed in other general purpose lanes is also used as an additional input to the detection of whether the user is on the HOV lane.

This becomes even more problematic when the road is curved in certain sections, in which more location samples are required to have high confidence of the lane the user is traveling on.

It should be understood that the server application (10) is configured to be adaptive to various inputs, including for example voice responses that the user may provide to voice prompts. For example, the platform may be asked by the user “Are you going to work?” or “Are you going to 123 Main St.” if a threshold of likelihood is met. In one aspect of the invention, the system is configured to minimize distraction and also annoyance and therefore is likely to avoid requesting such feedback. In one aspect of the invention, the mobile application (16) and/or the server application (10) is operable to analyze voice commands received in response to such voice prompts and analyze these to identify possible annoyance or frustration, based on one or more voice analysis routines, and automatically modify one or more thresholds to minimize the sending such voice prompts in the future. For example, in one aspect, the platform may be configured to listen for certain words that express frustration and as well as the inflection of high than normal pitch of that individual to identify possible annoyance or frustration.

In one aspect of the invention, the system of the present invention analyzes voice spoken to the mobile application using for example a natural language traffic reporting utility. In one aspect, the utility is programmed to deduce the geographic area associated with the user's incident report. The utility may be programmed to capture incident reporting information from the user in a variety of ways. In one aspect of the utility, it implements a speech to text operation to convert the speech into words and sentences. The utility analyzes the full sentence and all the words within the sentence at the same time to determine if there is a match to any of the relevant key words anywhere in the sentence. Key words in one implementation include (1) the incident specifics, such as accident, crash, maintenance, construction, closed, reduced, cleared, (2) location propositions such as, ‘between’, ‘at’, ‘approaching’, ‘beyond’, ‘north of’, ‘south of’ ‘east of’, ‘west of’, and (3) the street names in the city or immediate location around where the users are reporting incident. Should there be more than one match, the system may be operable to rank the matches, and optionally suggest a best match. The sentences and each of the word spoken from the user is analysed using key word and phrase search as described above to generate the most accurate match of the details of which street, direction and the type of incident the users is reporting.

When a user reports an incident by calling in to the system, or Tweeting the system, pressing various buttons displayed by the mobile application, the platform performs certain validation in order to ensure that the incident reports are of high quality. Prior art technologies typically ensure that the users are close to the area of incident. The present invention ensures that the location of the user reporting the incident report is on a particular road way, travelling in a particular direction, and that their travel speed is relatively slow and aligns with the type of incident reported. The system may also build a confidence score when there are more than one users reporting the same or similar incident in the same proximity. The system may be operable to perform additional, more advanced checks such as detecting quick deceleration by the user. The location and travel speed of the users calling in is also captured to support validation by the system of the report, as well as to give higher priority of matches that are relevant to the user's current location (street or area).

The credibility of the user's previous report is also a factor in setting the credibililty score. After the confidence score reaches a certain threshold, the system may be configured to use that incident as a valid incident for traffic announcement. For other incidents that do not meet the threshold for announcement but are still worth investigating based on having met a lower threshold for example, these incidents may be routed to an operator for further validation.

The system may also further infer other incidents related to the reported incidents in a scenario such as having an accident in an intersection in which the system may generate four incidents, one for each driving direction to the intersection of concern. In the case of a major incident of a highway in a certain direction, the system will generate another incident of the opposite direction as users/drivers typically slow down to look at the aftermath of the incident.

In another aspect of the system, the match results may not be sufficient to match the natural language of traffic reports to the criteria mentioned above, there is a minimal threshold in which the system will not automatically process the report, and will be sent to a operator for human validation. The operator will further analyze the cause of such failure to match and be able to enhance the system to recognize the report at a future time, such as by adding a alternative reference to the road name, land mark or other user reported linguistic phrase, or other patterns the system could have recognized.

Should the natural speech recognition utility determine that the user reported an accident that has just been cleared, the system will locate any relevant accident in the same area of concern and try to designate the accident as being expired and also use the accident in a new announcement in order to announce to users that the accident has just been cleared.

Various other enhancements may be added to the system such as different weighting techniques, priority tuning, additional feedback mechanisms that may be used to improve performance.

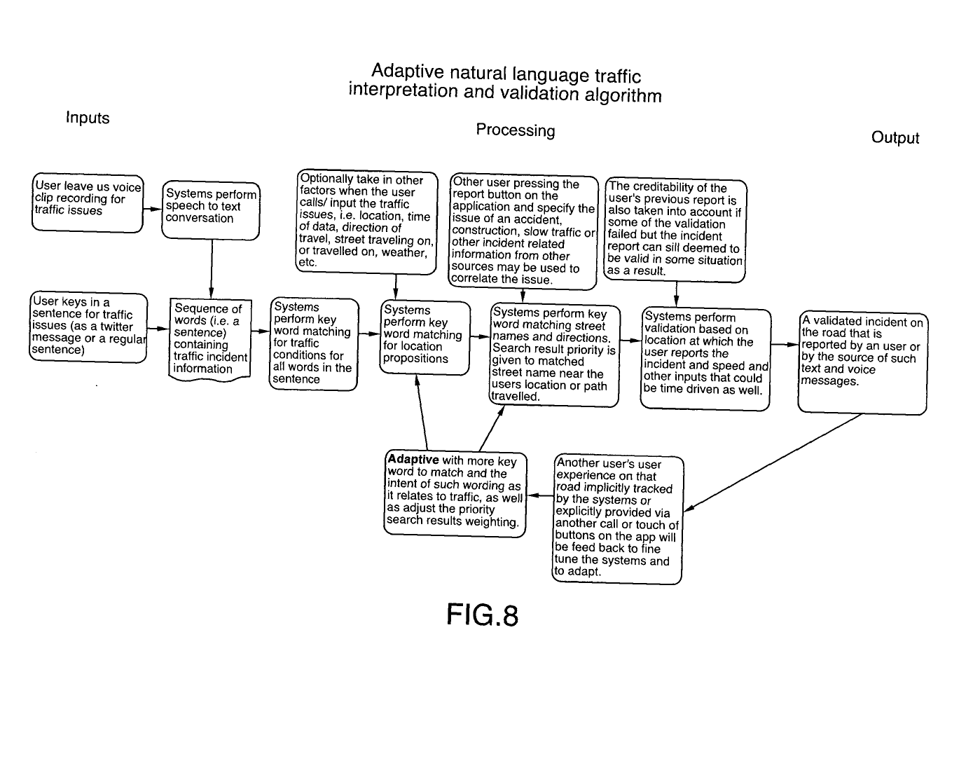

FIG. 8 illustrates one possible implementation of such adaptive natural language utility of the present invention. For example, as inputs, the platform may receive a user voice recording clip describing traffic issues, upon which the platform may perform speech to text conversion. The platform may also receive a email, twitter message, or any other type of data communication from a user. Upon any input received, the platform parse the input for key words matching traffic conditions that the platform is preconfigured to recognize. Optionally, the platform may consider other factors including the time of when the user calls in or inputs the traffic data message, the location of the user, the direction of user travel, the street upon which the user is or was traveling, the weather conditions, or other factors. The platform may perform key word matching for location propositions. Data received from the user may be compared with data received from other users or from other sources in order to correlate or verify the related traffic issue or condition. The platform may perform key word matching street names and directions of the traffic condition. The platform may prioritize matched street names near the user's location or path traveled. The credibility of the user's previous report may also be taken into account if some of the validation failed but the incident report can still be deemed to be valid in some situations as a result. The platform may perform validation based on location at which the user reported the incident and speed of travel, and other inputs that could be time driven as well. A validated incident on the road that is reported by a user or by the source of such text and voice messages may then be outputted as needed to users of the platform. Another user's users experience on the respective road implicitly tracked by the system or explicitly provided via another call or touch of buttons on the application of the platform may be fed back to fine-tune and adapt the platform accordingly. The platform may be adaptive with more key words to match and the intent of such wording as it relates to traffic, as well as adjust the priority search results weighting.

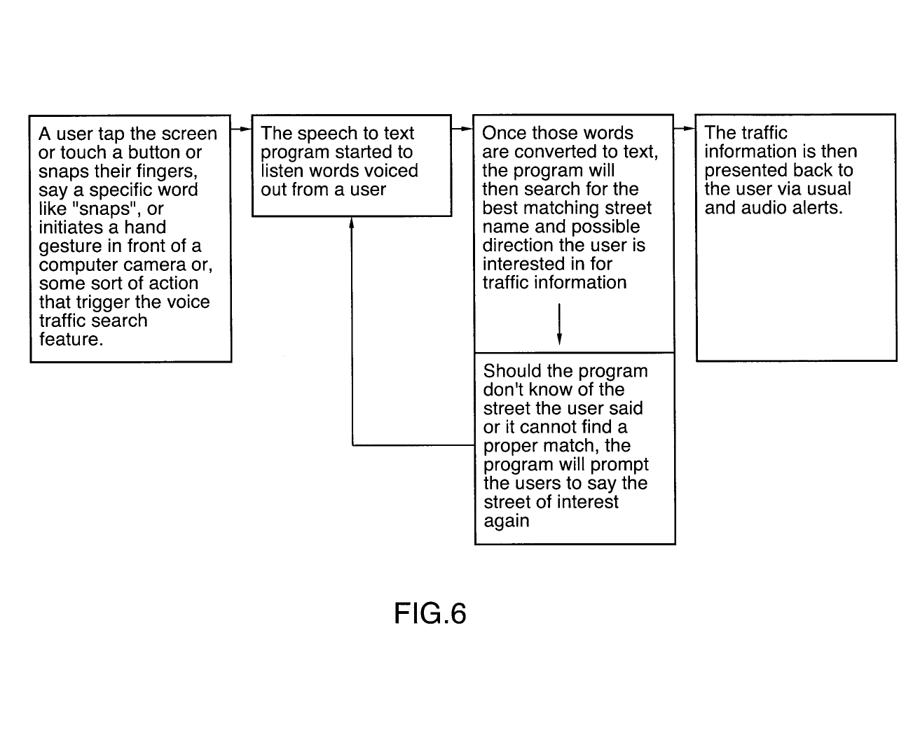

FIG. 6 illustrates one possible implementation of an aspect of the present invention. In this non-limiting exemplary implementation, a user may tap a screen or touch a button of a mobile device located at a transportation vehicle of which the user may be an occupant. The user may alternatively say a word, such as the word “snaps”, or initiate a hand gesture in front of a camera in communication with the mobile device, or some sort of other action may be performed that triggers a voice traffic search feature of the mobile device. The mobile device may invoke a mobile application or operate a previously invoked mobile application to begin to listen for words voice out from a user. Once a word is spoken, and converted to text by the mobile application, or the mobile application together with other aspects of the platform, may search for a matching street name and possible direction the user may be interested in for traffic information. Should the platform not recognize the street indicated by the user, or if it cannot find a proper match, the platform may prompt the user to say the street of interest again for further processing by the platform. Once a match is identified by the platform, corresponding traffic information may be presented back to the user via visual and audio alerts.

In another aspect of the system, the validation of the incident can also be achieved by other users who have just heard an ‘un-validated’ traffic report. The user who have just heard about such incident will be able to validate such report by, but not limited to, touching a button on the mobile device, or verbally acknowledge this is a correct incident. The originator of such a report can also be credited or acknowledged of such report, either by, but not limited to, a recognition note on the system, points awarded in an incentive systems or any monetary measure. Any users who have reported numerous times and also get those reports validated by other users may also be awarded various user status in the system, and therefore providing more incentive for user to report and validate traffic. Those users who validate the incident may also be rewarded similarly.

In a particular aspect of the present invention the server application (10) is operable to determine multiple users who are travelling in the same direction, along the same or a similar route, and dynamically link these users to form a group of associated users based on their likely common interest in receiving traffic information and other information. The relevant aspects of the profiles of some these users may include more information than other users. Also, one or more users of the group may provide feedback to the platform for example by using voice commands to request particular information. The collection of profiles and such feedback may be used, for example by applying one or more data processing operations for determining an interest profile for the group, and using this profile to filter traffic information in an intuitive manner. Various known techniques may be used for dynamically building group interest profiles.

The display of traffic information by operation of the mobile application (16) may be based on one or preferences which may be provided by the user based on use of a settings facility that is presented to the user, for example to obtain and store to a user profile settings relating to volume preferences, voice prompt preferences, speed of speaking, traffic information display preferences and so on. These settings may determine the way in which traffic information is delivered to a particular user using their mobile application (16).

In one aspect of the invention, the platform of the present invention may implement the features as described above, by the server application (10) including the following key utilities: (A) a content filtering engine, a (B) content prediction engine, and (C) a content adaptation engine. These engines cooperate to significantly improve the relevance of content over prior art solutions.

### Content Filtering Engine

In one aspect of the invention, the content filtering engine, may filter content based on one or more of the following: (i) day of the week, (ii) time of the day, (iii) traffic conditions, (iv) weather conditions, or (v) available advertising/offers. As stated earlier, the content filtering engine is operable to filter information for the group of users at a similar location. The content filtering engine may also in addition filter based on personal preferences of the user. But one advantage of the invention, and one of the innovations, is to filter based on the group and therefore providing a non-personalized filtering engine that provides desirable performance and scalability.

### Content Prediction Engine

In another aspect of the invention, the filtered content is obtained by the content filtering engine, and then additional filtering operations are enabled by the content prediction engine based on predicting the filtered content that will be most relevant to the user, based on one or more of the following factors: (A) exact user location, driving direction and destination (if destination is unknown then the system predicts destination based on past driving history logged to the profile); (B) the user's past routes to the destination (also accessed from the profile); (C) one or more attributes of the user relevant to determining highly targeted advertising (relevant to implementations that include advertising); (D) feedback logged to the profile in the past by operation of the content adaptation engine explained below. The content prediction engine is operable to determine a subset of the filtered content that it is predicted will be of interest to the user, and this content is delivered to the user as described above.

### Content Adaptation Engine

In one aspect of the invention, the platform also includes a content adaptation engine. The content adaptation engine is operable to track user response to content. This includes explicit response by providing for example voice responses, applying one or more speech recognition operations and analyzing the voice responses to extract meaningful user feedback linked in the system to the content that is associated with the feedback. It should be understood that in one implementation of the invention, the feedback is tagged and sent to the server computer (14) in voice form. The content adaptation engine may be implemented using a number of different distributed architectures of the present invention.

In a particular implementation of the invention the content adaptation engine is operable to extract from user feedback relevant content for adapting content, and this information is stored to the user's profile by operation of the profile manager (24), for example in one or more profile areas that store information suitable for adaptation of content, for example by the content prediction engine in future instances of content filtering and delivery.

It should be understood that the content adaptation engine is also operable to log user activity, and analyze user activity to extract implicit user feedback, and provide this information to the server application (10). For example, driving decision changes based on traffic information reports delivered by the platform may be analyzed to extract relevant information for improving operations of the platform, for the particular user.

In one aspect of the invention, the content adaptation engine is operable to interoperate with profile manager (24) and to manage a series of content preferences for the user. In one particular implementation, the adaptation of content based on user feedback will depend on a number of factors such as time of day, day of week, month of year, traffic conditions, weather conditions, and ad/offer preferences. User feedback is logged to the profile based on these and other parameters to place the user feedback in a context that supports better filtering of content and adaptation to user intent. With increased usage the profile continues to be built and enhanced, enabling continuing improvement of the ability of the platform to interpret user intent, and also adapting the profile over time to new user preferences or driving patterns. Various other extensions of this functionality are possible such as for example the ability to link the platform with third party loyalty systems to link the platform of the present invention with for example coupons made available through third party loyalty systems.

For example, the platform using the content adaptation engine is able to construct viable alternate paths tied to certain traffic information. In a particular implementation of the invention, the platform is operable to analyze input of the content adaptation engine to a plurality of profiles, for example, by detecting recurring slow traffic conditions; analyzing alternate paths taken by one or more users; comparing the travel times on these alternate routes; and using the alternate paths in future content delivered to users. This analysis across a related group of users may occur in real time. It is important to understand that therefore in accordance with one aspect of the invention, the content of the platform, for example suggestions of alternate travel paths, may be based in real time or near real time on alternate paths taken by other users who are part of the group, who are traveling along a similar path, based on determination of the success of other users by taking an alternate path. In other words, the platform of the present invention includes a crowd based, location based travel path suggestion engine which represents a very significant and innovative advancement over the prior art. In one aspect of the invention a novel travel route optimizer is provided, as described.

### Permission Based User Generated Platform

In another aspect of the invention, the platform will ask for the popular destinations of the user and ask he/she to enter them. The system will then automatically provide all or some of the possible routes between the destinations to reduce the time user needs to set up individual routes. Those destination can be but not limited to home, work, day care locations.

the platform may also ask if the users want to hear additional content of their interest during their drive time and therefore provide more personalize content that is highly relevant to their drive time. For example, we may ask the user if he/she want to hear coffee and breakfast related information in his/her morning drive, or local breaking news, grocery store's specials on the routes he/she takes. The preference can also be getting more specific to the brands of the users interest, such as Starbucks, or McDonald's, or just a category store or community news.

In another aspect of the invention, such highly relevant information can be provided by a content producer (i.e. merchant or company, or individual, or community centres) who want to send such relevant message and content in visual and audio format with a easy to use self serve program. Those relevant content can be geo-tagged, categorized, and also have expiry if relevant to fit users preference and get played to them in a relevant manner. These message can for example easily record such messages using a mobile app, by recording the audio message using the microphone of the smart phone, taking pictures or video using camera of the smart phone to create a multi-sensory message to be delivery to relevant users based matching the serving parameters and the user's preference.

When there is a match between what the user want to hear and what a content producer wants to serve based on the set parameter, the system will push such message to the user. The user can forward, repeat, let the system know if they don't like or like it; and other user can also follow the content that another users (e.g a friend) had listen to or liked. Content can then further categorized by the number of times it has been liked, leading to making a list of top most liked content, etc.

The content producer can track how many people listen to their content & messages, and how many people like it, and have shared it.

Having a systems like this will enable content to be created easily while providing a mechanism to filter and This is a way to effectively to categorize and rate user generated content, make the most useful, relevant and popular content to stay get consume more than other less useful, relevant and popular ones.

Another aspect of this invention is to have the user response to such user generated content, as such content can have a call to action for the user, such as asking them a question, or asking them to tap the screen or saying something to obtain further information. In a specific case, the user generated content can be from a user on the same road behind another user, and ask how is the traffic or road conditions ahead.

Some other form of user generated content can be about topics such as the best children day camp in near the location the user is or near the destination that the user had set.

### System Implementation

In one implementation, the platform collects data from the user's location, in assembling relevant content also includes one or more user reported incidents, together with other 3rd party traffic incident reports. Traffic flow information is anonymously collected from all live users in of the platform, and also by applying one or more traffic forecasting engine predictions. This information is used to generate personal traffic updates at right time at the right location. These are automatically pushed to users, in one implementation of the invention.

In one particular implementation the content includes a report (which may be displayed or part of a voice report) that includes an approximation of the delay, providing therefore a decision support element to enable users to decide whether to make route changes. It should be understood that the delay approximation information that is possible based on the platform of the present invention is more accurate than what is possible based on prior art techniques or technologies, in part based on real time collection of information from a group of users who are in the same location and driving in the same direction, and other aspects besides such as the monitoring of alternate paths as also referred to above. It is also important to note that the present platform may be operable generate incident data such as the reasons for a traffic delay, which may be generated on a crowd sourced basis, as discussed.

The features of the platform and a representative workflow may be understood, referring to FIG. 1. It should be understood that variations are possible.

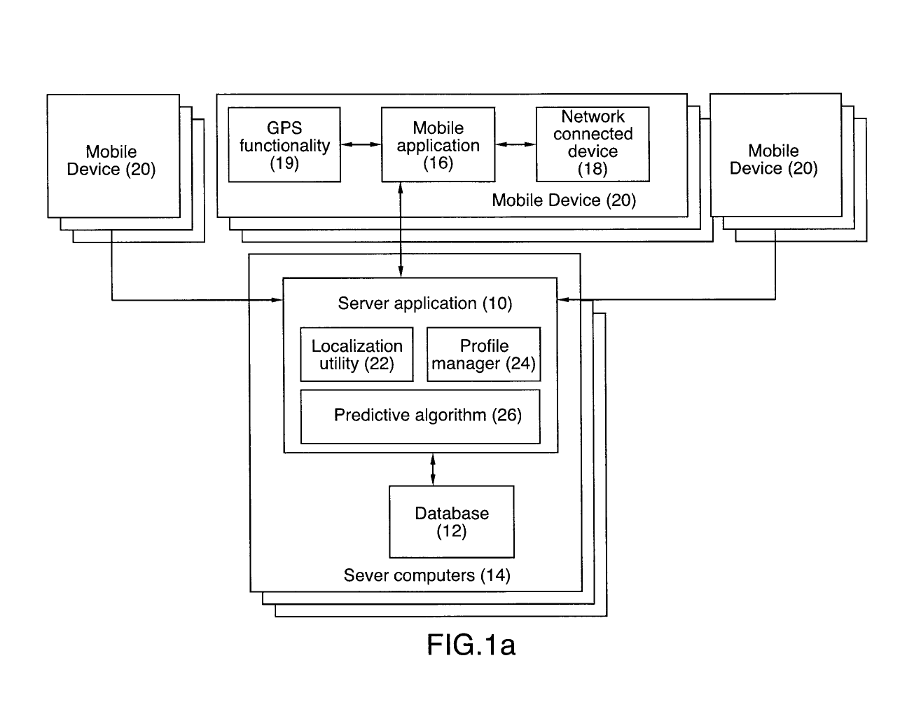

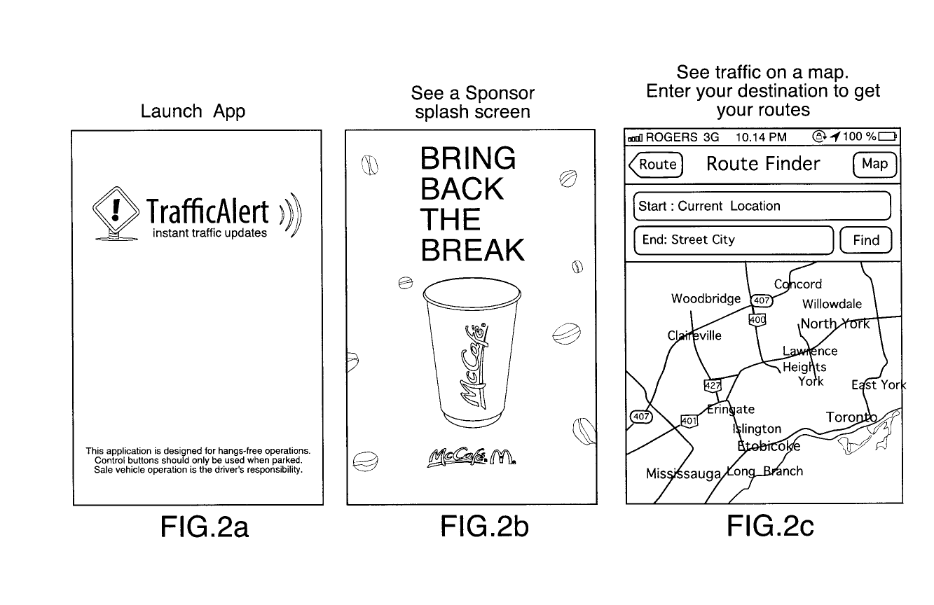

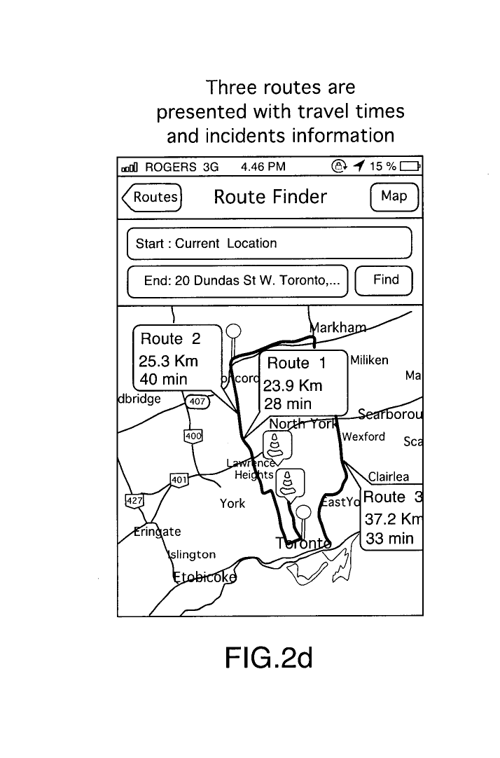

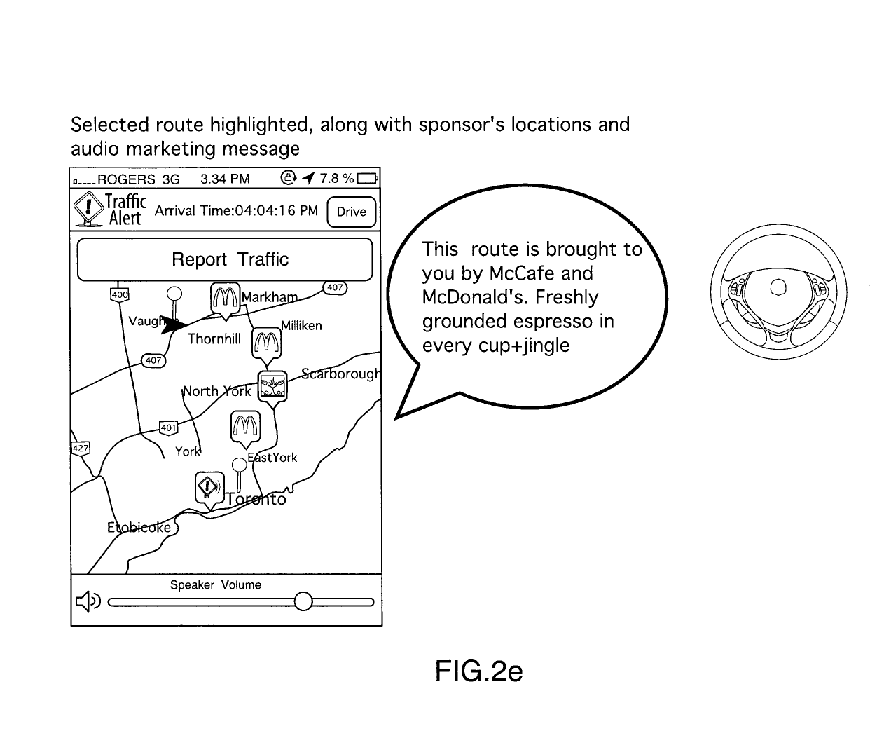

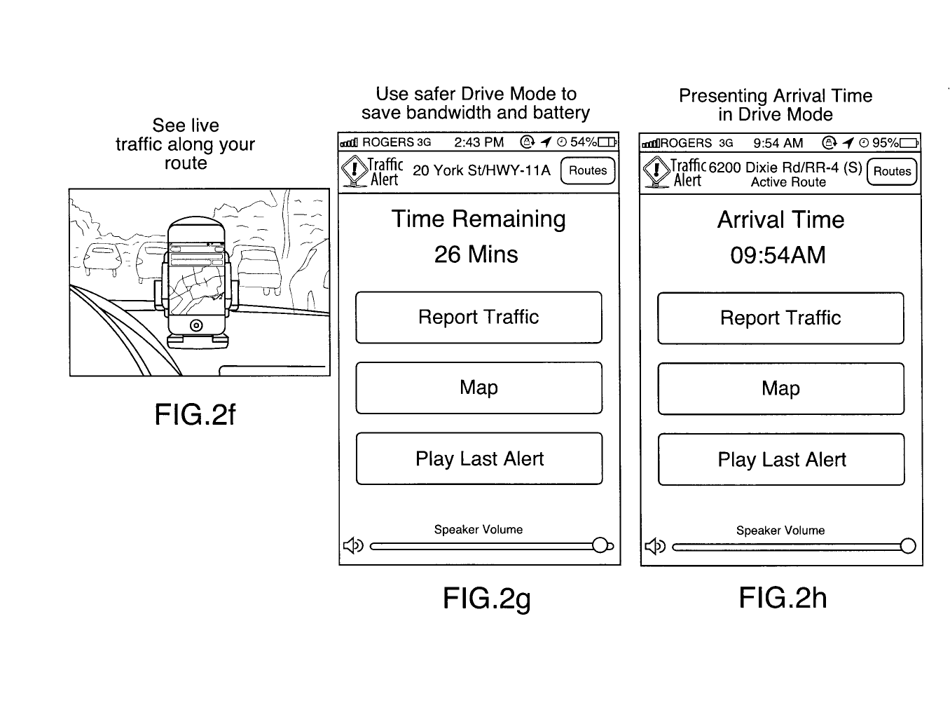

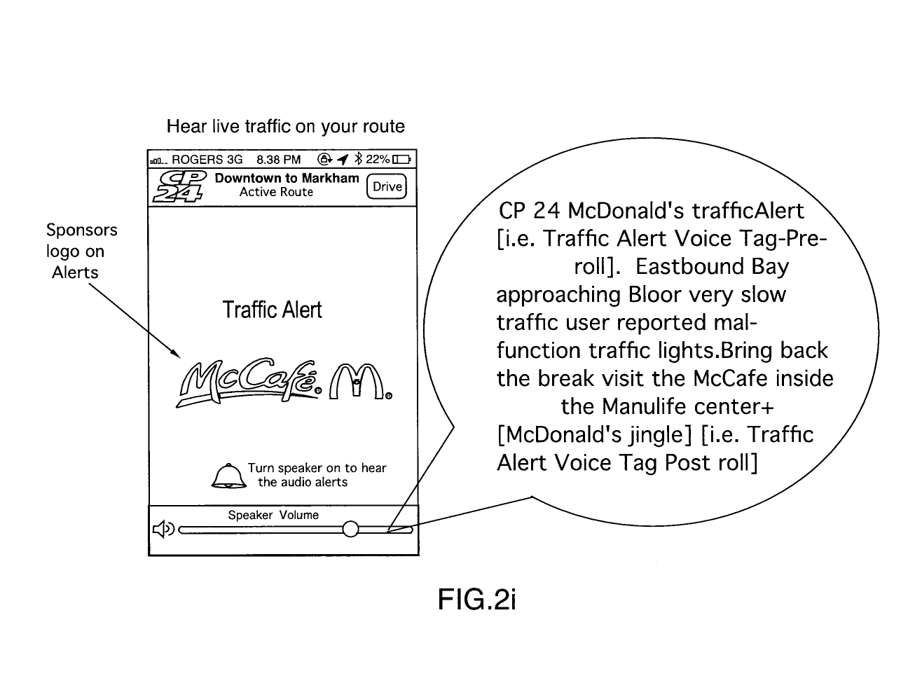

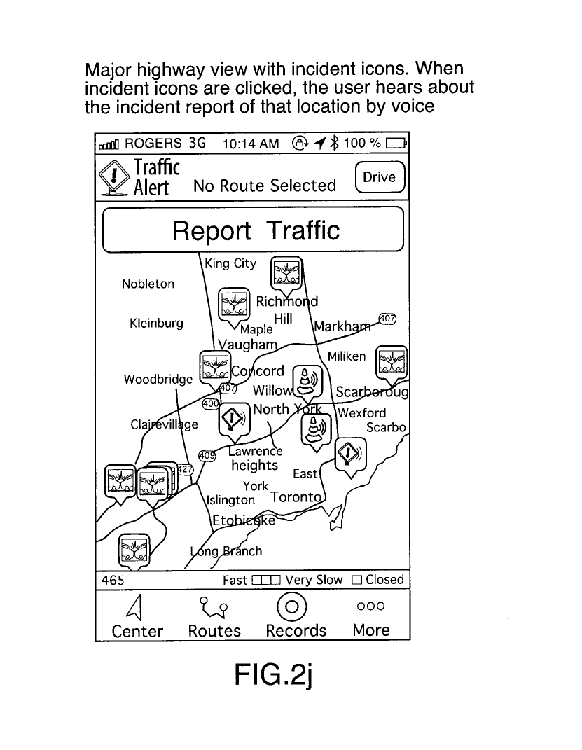

As shown, upon a mobile device in a transportation vehicle, there may be installed or downloaded a mobile application. The mobile application may provide for an in-car experience (1) that is optionally personal, context-aware, and safe to use while driving, providing news, entertainment, or other information to the user or general occupant of the vehicle. The user is may launch the mobile application before starting on a journey in the transportation vehicle. Real-time location, voice, sound, or touch inputs received at the mobile device may be transmitted to the location-based content layer of the platform, which may comprise personalization traffic engine (5), advertisement engine (6), news/info/entertainment mobile content engine (7), and push notification engine (8). Information may be pushed to the mobile application or pulled from various layers of the platform particularly from voice & visual announcement and interactive technology layer (3) or adaptive/learning layer (4). The mobile application may include a rich user interactive portal (17). The adaptive/learning layer (4) may adapt to or learn from other users, communities, routes, and advertisement analytics (11). Any of these layers may also interface with incentive layer (9), social layer (10) or integration layer (12). Integration layer (12) may interact with other location data collectors (13), other mobile and LBS applications (14), external events and integration feeds (15), and media integration (16), optionally through a SaaS application programming interface (“API”). Initially the mobile application may receive and display real-time traffic information for major highway traffic that is proximate to the location of the user, as measured by a GPS unit of the mobile device, through cell-network positioning, by receiving an indication of the user's position from the user, or by other methods. This may be shown in a map view of the mobile application such as that shown in FIG. 2c. This may enables the user to see the traffic condition on the most commonly traveled highways within a few seconds. The user may be prompted by the mobile application to start recording his/her trip. In one implementation, the user presses a record button by one or more screens displayed by the mobile application. The mobile application automatically tracks the user's route using GPS information, or through other tracking or location-determining methods. During the recording, the platform is already working to look ahead of the driver's current location based on a prediction of next route segments. The mobile application, working with the server computer, is operable to deliver to the user notification of adverse conditions. The user may press a stop button when reaching the destination. The mobile application may invite the user to name the route. Whenever the user travels that route again, the user may call up the route for example by accessing a menu of the mobile application which may be accessed using input commands to the mobile device, whether voice commands or otherwise. The mobile application may be operable display the selected route on a map that indicates for example in coloured segments the real-time traffic conditions relevant to the route. The platform may also initiate one or more related voice commands. A representative screen illustrating these functions is shown in FIG. 2j. The mobile application may also be pre-loaded with a list of popular routes based on the location of the user, as shown in FIG. 2d. In a particular implementation, the mobile application in its hands-free mode starts alerting the user of relevant real time information such as sudden traffic jams occurring between the user and its destination, giving the user ample time to take an alternate route decision. It should be understood that the present invention based on its crowd source model of capture of relevant information is operable to improved real time traffic information that in many instances is not available using prior art platforms or techniques. As the user drives on the road, the user sees live traffic on its route, for examples as shown in FIG. 2d. By operation of the platform, the user may learn about traffic problems ahead. The platform may pushes visual and voice traffic alerts to the mobile device, filtered as described, so as to in effect deliver a personalized traffic report, for example as described in FIG. 2i. The user easily consumes this content and can plan for alternate routes.

In another aspect of the invention, the platform is operable to filter and deliver to users relevant location based voice and visual advertisements together with the personal traffic report of the present invention. This enables the monetization of the invention and may enable the provision of the service to users for free, or at a reduced cost. Non-limiting examples of possible advertisements implemented on the platform include: (A) “‘CP24’ Traffic Alert (the title sponsor), Gardiner eastbound right lane blocked at Spadina (Personal Traffic Report), brought to you by your local car dealership at Yonge and Finch” (location based advertiser); (B) “Gas prices will rise 40 tomorrow. Esso station next exit”; (C) “It is 6 pm. Traffic is moving at 20 to 40 kmh. Click here to call and place a takeout order for the Swiss Chalet at the next exit”; and (D) “It is snowing. Canadian Tire is having a special winter tire package 3 km from here. No appointment necessary, just drop in can get it done within an hour.”

Accordingly, the platform of the present invention may provide voice enabled contextual advertising on an IP device, and in particular on an IP connected device while driving. In essence, the platform may provide for personalized radio style advertising, enabling specific targeting and in connection with a platform where the user is part of a captive audience. Advertising through the platform may be highly valued by advertisers as it may provide previously unavailable location targeting of drivers and unique interest based targeting.

Advertising enabled by the present invention may be measurable by the platform by enabling for example an automated check-in function based on GPS information. For example, the automated check-in can be based on the proximity of the user within the location of interest, as well as the duration in which the user stays in that proximity. Alternatively, the loss of or degradation of a GPS signal can also be utilized by the platform to determine if the user has checked-in automatically.

The platform may also provide, for example based on user preferences, other location based and time relevant information that enable users to be more productive and save money. For example as a user approaches a gas station that has a special offer, real time, location based ads may be provided to the user.

The platform, as explained above, offers alternate route suggestions based at least partly on at least one previous route the user had driven and the intelligence harvested from all users who drove from the same origination to the same destinations.

The platform may also enable users to pull information on demand by asking questions such as, “tell me traffic on Yonge street” by speaking to the mobile application or by touching a few buttons.

The platform, in one implementation, may be also configured to integrate with other IP based services such as for example streaming music or Internet radio, or personalized music services such as PANDORA™. For example, the user can launch the mobile application while listening to PANDORA for their personalized music streaming on Internet radio, and when a personal traffic report is to be served to the user, the music will fade out and pause to enable the consumption of the report or other services for the platform, enabling the personal traffic report to be played. Afterwards, the music content may resume. The integration of the platform with a music streaming service is a useful way to make use of the ‘void’ time between alerts.

With such integration to other audio based content, streaming music or internet radio, a suitable advertising serving algorithm may in one implementation take into account the song choice or the stations and genre choice as part of the targeting of advertisements through the platform, allowing for better relevancy for both the content publisher, and the advertiser.

The platform may be also designed to introduce an interactive element to enhance the user's in-car experience. The platform sends out a call to action message, triggered by a person or a system, to the user based on some targeted criteria such as but not limited to, those users who are stuck in traffic, on a specific road, or at a specific time. This call to action message will be shown and voice-announced to the user. The user will then be called to response to the message by calling back via the cellular or IP network to the originator, enabling an interactive or live two-way communication. This can be used by a TV host or a Radio DJ to send a call to action message to those who are stuck in traffic and have those users report live traffic back to the TV host/Radio DJ. This technology introduces an interactive element to a broadcasting focused media such as TV or Radio, making broadcasters interactive. As a way to make this more rewarding and fun, the system can also enable a contest in which the first caller will receive a prize from the person or company that triggers such message.

In another implementation, and as discussed in part above, while the user is driving, the platform can also send out automatic notifications of other possibly faster, safer, or ‘more pleasant’ routes to the users based on the crowd sourcing of the various for example shortcut routes going to the same destination that has saved users time. This is one of the insights platform is operable to derive by applying data mining and analytics by operation of the server application (10), thereby for example mining all the route data and driving habits of users with similar profiles and context. This allows better use of the road systems in less commonly known routes as well as offering possibly ‘better’ alternative routes to the users. This content is highly innovative and advantageous to a given community. In one aspect, the platform is able to rate the effectiveness of particular routes based on implicit or explicit rating by the community, including based on logging the time the elapses when users drive along a shortcut. Prior art technologies do not disclose a platform that enables the collection, dissimulation, and validation of such information to a community of users.

As the platform is providing relevant information or alternative routes to the users while driving, the platform allows for a way to rate routes; suggest new routes, and a way of rating the existing recommendations. In one particular implementation, the platform is operable to generate and deliver to the user a social context associated with a suggested route.

For example, the route suggestion service may link to third party social networking environments for example to enable for example specific route suggestions to be linked social contacts, a first user who is friends in a social networking environment with a second user, where the first user believes for example that the second user may know travel paths such as shortcuts that may be of interest to the first user, a first user may through the platform of the present invention elect to follow shortcuts defined by the second user, whether explicitly or implicitly. The platform of the present invention by integrate various other social interactions. In addition users may attach a rating to a particular shortcut. An incentive system linked to the platform or part of the platform may provide incentives to users for suggesting alternate paths, including based for example on a rating of the path, as initiated by one or more other users through the platform.

The platform may be configured to automatically publish information to one or more third party social networks such as FACEBOOK™ (for example using the Open Graph) by automatically posting to users' FACEBOOK walls every time they perform an action or rating within platform, thus generating more user engagement, product exposures to their friends, and signups.

For the suggested route specifically, the users can browse/search those suggested routes from their friends and networks, in one implementation.

The platform may be configured to solicit and receive ratings and other feedback at the end of every trip, thereby enhancing the platform's ability to adapt for the user its content including recommendations, and the manner in which such content is delivered. For example, ratings may related to whether the user arrived late, early, on-time, had difficulty finding parking, did not get warning of an accident ahead, etc. This feedback may be solicited in an easy to use way (for example using voice prompts and commands, or a short and easy to fill survey). Provision of feedback may be encouraged using an inventive system and optionally gamification.

In a particular implementation, the platform is operable to log kilometres driven and assign reward points by operation of the incentive system, as a mechanism to build loyalty for example. Various other incentive systems or programs may be implemented to drive user behaviour that is desirable to the operator of the platform or its customers such as advertisers.

In another aspect of the invention, the platform may incorporate one or more features to enable users to discover, categorize and subsequently initiate the deliver of content in a location aware manner. For example, the platform may incorporate or integrate with a musical content delivery service, and enable users for example to associate particular musical content with a travel path by operation of the platform. Users may also indicate their interest to receive offers that meet certain parameters along certain paths, at certain time. For example on a user's morning drive to work, the user may be interested in special offers or coupons to purchase coffee or breakfast items. On their way home driving past several grocery stores for example, they may be interested in receiving particular offers (which may be delivered using voice prompts for example—“Product X is on sale for Y at Z”).

With reference to FIGS. 2a through 2j, in accordance with implementations of the present invention, exemplary screenshots of the mobile application are shown such that: FIG. 2a shows a launch screen of the mobile application; FIG. 2b shows a sponsor splash screen; FIG. 2c shows traffic on a map where the user may enter a destination to get routes; FIG. 2d shows three routes with travel times and incident information; FIG. 2e shows selected route highlighted, along with sponsor's locations and audio marketing messages; FIG. 2f shows live traffic along the route; FIG. 2g shows safer drive mode to save bandwidth and battery life; FIG. 2h shows presenting arrival time in drive mode; FIG. 2i shows an audio indication being played on the mobile application describing a traffic alert; FIG. 2j shows a major highway view with traffic incident icons such that when an incident icon is selected, the user hears about the incident report of that location by voice.

### Additional Features

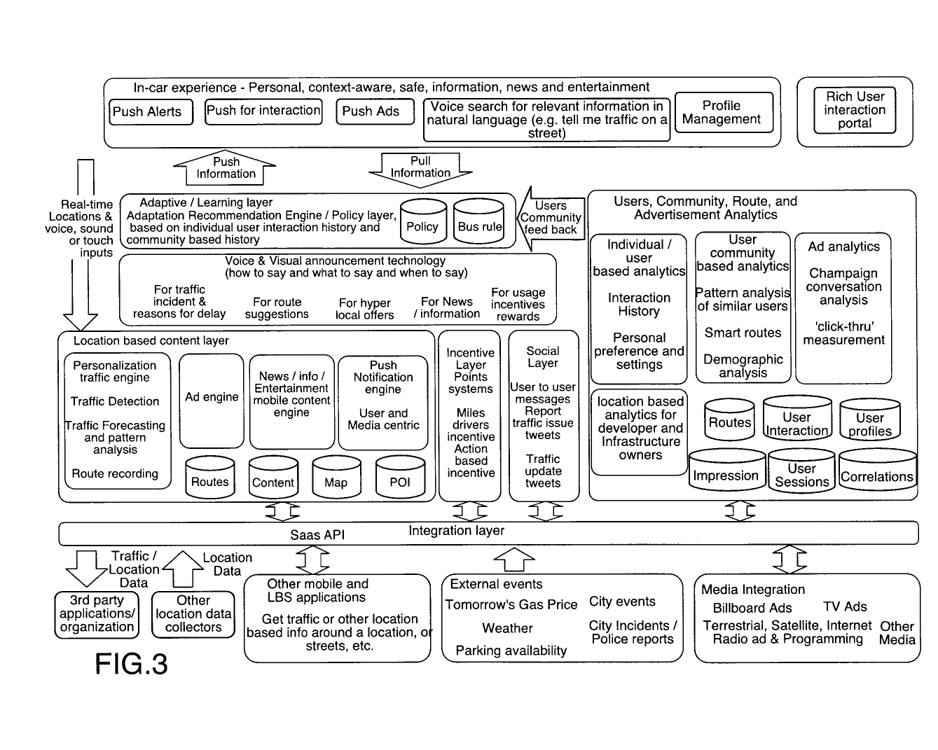

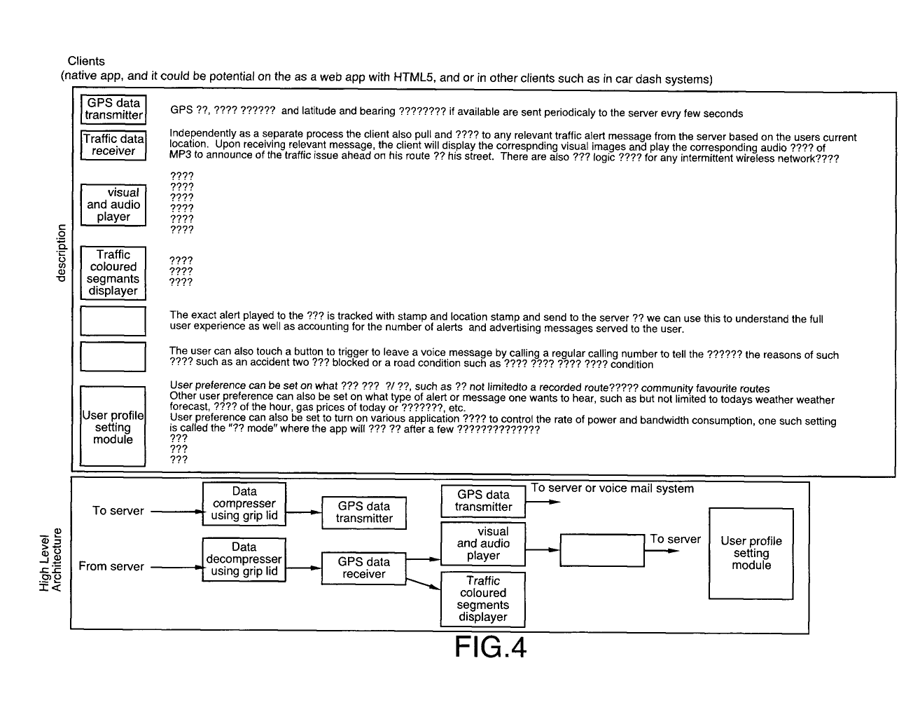

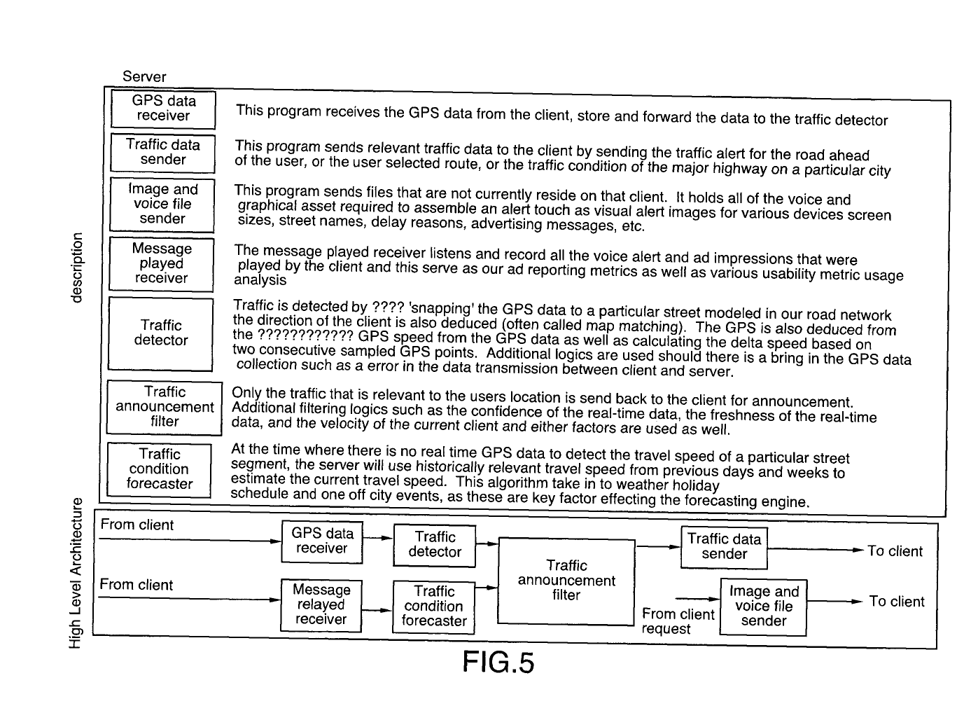

Referring to FIG. 3, various other possible features of the platform of the present invention are explained. Similarly, FIGS. 4 and 5 summarize additional client side and server side features mentioned herein, in one particular implementation of the platform.

The platform is configured to be able to constantly listen to the user's input such as a voice commands or other sounds such as snapping of fingers), and other touch points such as the pressing of a button or a tap on the screen of a mobile device. Other inputs are possible such a gestures within proximity of the mobile device in a “listening mode” of the mobile application. These inputs, together with all other input collected automatically such as the time and locations of the users, are sent to the server computer.

In one aspect of the invention, the platform is operable to provide a multi-sensory experience with a primary focus on voice input/output for improved driver safety. The present invention may incorporate or link to various voice recognition platforms and techniques.

In a particular implementation of the invention, the voice delivery component may be configured to ensure that one or more rules are met to ensure optimal delivery of voice content. For example the rules may embody configuration of voice messages to ensure that there is use of proper speed of the sentence (i.e. cadence); composition of voice messages that are concise and actionable, especially in light of the fact that voice messages will typically interrupt audio content that users consume when driving. The careful production of voice content such as alerts ensures that voice messages are highly relevant and easy to hear and understand. An easy replay feature is provided based on voice or other commands to enable the user to hear information again. As platform optimizes the delivery of the content, including by supporting multiple languages; ensuring that voice alerts are received early enough; ensuring that alerts including not just problem but also solutions (such as alternate routes based on the fact that the system monitors for the user not just its current street or highway but intersecting and parallel travel paths as well).

In a particular implementation, the platform is operable to deliver voice alerts or other messages by stringing individual words or phrases together contained in voice files (i.e. MP3). These files are then played in particular sequence according to a ‘playlist’ defined to produce the sentence, and sometimes with delays and pauses in between to ensure the users can hear them properly while driving. Other implementations are possible.

In a particular feature, an introduction tune may be played before a voice alert for all the users to ‘tune-in’ to the message. Users as part of the setting utility may select a preferred introduction tune from a range of possibilities.

In one implementation, new voice messages may only be delivered if they are related to an earlier message, if the new message represents a substantial or significant change, as determined bases on one or more analytical operations of the server application (10).

A visual alert is often served together with the audio message to create the multi-sensory experience and a higher recall rate.

In another particular aspect of implementation, the platform may link with a third party ordering system or other Internet service, and based on one or more user parameters, the mobile application may be operable to initiate an input means to enable the user to trigger for example a report on traffic, a response to a message, an indication of interest in an offer linked to an advertisement, or an order or pre-order of a product. The input means may consist of a voice prompt or the display of a button such as “ORDER”. For example, a user may want to order or pre-order their favourite breakfast meal as they approach a business where they have placed this order before. The platform may integrate with various other platforms to link to various information relevant to a user such as their meal preferences, for example.

### Device Resource Optimization

In another implementation, the platform includes one or more features that enable optimization of mobile device resources such as (i.e. bandwidth, battery power, as screen pixels). In one aspect, the screen may be dimmed while users are using the mobile application in their vehicle. In another aspect, when a visual alert is delivered the mobile device is returned to normal screen brightness. And then after for example a set time, the screen may fade back.

In a particular implementation, consumption of bandwidth and battery power may be optimized by dimming the screen on the display as well as stopping the map tiles from updating while the user is running the mobile application on the road. Since the user should be focusing on driving and having their eyes on the roads condition, they are not required to see the map view of the mobile application. By dimming the screen and stopping the tiles from updating until the user touches the screen to resume the map, the mobile application can save bandwidth and power by around up to 50% compared to running it with the full map updated all the time. With this ‘eco mode’ feature, the user will still be able to hear all the personalized voice and visual alerts as they will still be presented to the users and then the mobile application will go back to the eco-mode to continue to save bandwidth and battery consumptions.

A replay button is also there for users who may have missed hearing the alert.

The platform may also, in one implementation, take into account lane based speed as part of the traffic detection and travel path suggestion features of the invention. For example, the platform may suggest for example collector lanes as such which may not be considered different routes because they are alternate paths along the same route.

In another possible feature of the invention, the platform (1) detects speed of vehicles within a group of interest, for example based on one or more calculations using information provided by the mobile device to the server computer (14), and (2) the server application (10) provides instructions to the mobile application that result in the mobile application adjusting one or more graphical display elements to indicate visually the detected speed. For example, the mobile application may define a plurality of thresholds, each threshold being indicative of a speed range (which may be based in part on speed limits for the particular road or highway), and being represented by a different visual speed indication, and the detected speed will be represented by the corresponding visual indication of speed based on the range in which the detected speed belongs.

Another aspect of the invention, if a forecasting engine that may be linked to the platform or made part of the platform that enables the use of information including current weather, historical data, and current traffic parameters to predict traffic patterns for a particular travel path or segment.

End of Trip Report Based on all the Traffic Data Collected within Your Travel Time

The End of trip reports may include, in one particular implementation:
The actual time saved on the route the user completed, as compared to other possible routes based on the traffic condition and travel time if the user had travelled the other routes for example during the same time period during which the user had just driven.
The end of trip report can provide positive feedback and assurance. For example that you just save yourself 10 minutes.
Additional information such as the carbon emission/carbon credit/carbon footprint can be calculated by using the distance traveled, number of stops, the type of car, and other driving habits detectable by the mobile application. Some of these metrics may be collected automatically by the platform whereas other information may require user involvement for its collection such as indication of the number of passengers in the car, and the type of vehicle.
The end of trip report can also include the mileage driven for that trip, as well as any loyal points collected.
The end of trip report can also provide feedback on who has the best route based on the similar travel conditions as the users (i.e. time of day, weather condition, etc.).

The platform may include or link to a suitable ad engine that may be operable to serve ads based on relationships established by the operator of the platform with for example brands or media partners. The advertising may consist of visual and/or audio messages that are targeted based on weather, time of the day, phone type, wireless carrier type, location, whether the user is stuck in traffic, etc.

In a particular implementation, the platform provides a novel and innovative location based advertising engine that may also be used for the purpose of public service announcements based on location for example.

### Push Notifications

The traffic forecasting capabilities and the ability of the system to develop a rich profile that contains insight into the user's driving patterns can feed various other features including for example valuable push notifications. For example, even in advance of entering the vehicle or initiating the mobile application, the platform may know that the user is likely to be driving to work for example. Also, the platform may integrate with or include calendar functionality, and the platform may obtain information of meetings and locations and mode of transport in advance of the meeting. If a slower than normal drive is forecasted by operation of the present invention, then a notification may be generated by the platform, and this may be delivered through a variety of media to the user, and optionally for example by email notification to other attendees or for example by TWITTER™ feed. The user may determine his/her preferences related to such push notifications.

The notification may for example include the message, provided well in advance, that “Because of rain, and current traffic conditions, you need to leave 30 mins early for your meeting.”
Location Based Message Targeting for Users while Driving

In another aspect, for the purpose of identifying and serving the relevant voice and visual messages to users who are driving on the road, an location based utility may utilitze the user's direction of travel, the route of the user, the type of road the user drives on, the travelling speed, the distance and angle between the location of interest of the message and the user, and additionally frequency capping rules may be used.

Having an improved targeting utility in accordance with the present invention, enables the system to deliver more relevant location based messages to the user that the users register and initiates as positive response in users.

The system of the present invention may utilizes various techniques to detect the street and the direction of travel, and the angle between the points of interest, and the proximity of the advertised location and various priority lists and impression capping rules to ensure that the most relevant messages are send to our users. The system enables locations to be filtered out that are in the opposite direction of the travel.

Some of the key parameters that will affect the selection of messages include distance and angles between the user and the point of interest, how fast the user is travelling, and whether the user is driving on a highway vs. on a local street. For example if the users are driving on a highway, the system is operable to pick out messages that are further ahead of the users and pick out the travelling angle that is closer to the user, not necessarily pick out closer messages that has a larger angle to the user. The system may be further enhanced and provide even more targeted information by looking at time of day, current and future weather conditions, traffic conditions, and other environment and user profile variables.

In terms of frequency capping rules to limit the delivery of the same of similar messages, the system may include a mechanism whereby the same message or the same type of message will not be served to the users on the same day, or around the same location, time of day etc. Or the serving frequency would not be more than x numbers of times a day or more frequent than every x hours.

In terms of tracking the performance of a message delivered, the system may analyze the time of day and location in which the message is delivered, and how that may or may not change the user's driving behaviour, or how the user interacts with the application.

In another aspect of the invention, the system analyzes user trips to deduce if the user has visited the suggestion locations or the brand's location by counting the number of user trips that started or ended their journey near the point of interest (e.g. McDonald's restaurant in the GTA) during the marketing campaign. User trips that started, ended or that involved a stay for example of more than 2 minutes within 100-meters of a point of interest (McDonald's restaurant) may be identified as a potential McDonald's visit.

The system also takes into account the location of the point of interest if it is on the ground level or other locations that will need more direction. For example, if the location is a retail location disposed inside a relatively well known location or landmark, the message served may also contain more description such as the point of interest inside a mall, or in the underground food court, with the objective to make the message more actionable.

### Interactive Narrow-Casting Technology

In another particular extension of the platform of the present invention, the messaging system of the platform may be utilized to enable group communication between for example a group of users within a defined location, or a group of users perhaps at different locations but who share one or more common characteristics, for example they are social contacts, they are co-workers, they tend to travel a similar route, and so on. A designate of a group, for example one or more appointed users, or any member of the group, or a “Radio DJ” associated with the platform may initiate interactive communication sessions for example related to a “call to action”. This may relate to an emergency situation where information or assistance is being sought, in real time or near real time by operation of the platform, or information is sought by the platform from users for the benefit of other users. Alternatively, users may be proximate to a news scene for example a crime may have been committed where authorities may benefit from cooperation from a group of drivers near a crime scene, shortly after a crime has been committed, who are connected through the platform. The crime solving potential of transforming normally unaware and “blind” drivers into potential witnesses or sources of information is very significant.

This turns the users in to an instant journalist/reported for traffic or news. Those who take the call to action suggested can also receive incentive such as loyalty points or a gift, money, or a ranking on a leader board, etc.

In another aspect, the platform may provide a mechanism to connect a source of information directly to a news outlet or to the police for example.

It should be understood that in one aspect of the invention the platform enables the user, for example using a settings utility, to control the content that they receive, for example by managing a content “playlist”. In this way the user, can determine the type of content that they would like to receive by operation of the platform. To illustrate this aspect, the user may configure one or more settings so that the content receives (based on the voice functionality described) traffic alerts of the present platform, followed by local breaking news, then world financial news, and finally sports scores for the user's favourite teams or leagues, however, news items may be authorized for interruption based on availability of new traffic updates. Each user can determine their particular collection of such settings, thereby in effect accessing content that is customized for them.

The user may also configure one or more on demand functions. For example, a setting utility may be used by the user to configure one or more buttons on a screen interface for accessing selected content on an on demand basis. For example. in one possible implementation, a button may be configured for “LATEST LOCAL NEWS” and a user touches this button or uses a gesture for example in order to select this function, which thereby triggers the voice functionality to read local latest news files obtained by the platform.

### Incentive System

As explained earlier, the platform may include or may be linked to an incentive system for encouraging behaviour of users through rewards. Further details regarding particular aspects of such an incentive system are provided, but many other features and implementations are possible. Points may be and redeemed for prizes. Points can also be collected based on other actions such as ‘refer a friend’, or ‘call to report traffic’, etc.

### Social Layer

Additional possible social functions of the platform are now provided.

Everyone has their favourite shortcuts on how to get around their town. The platform provides a mechanism to enable the easy sharing of these using for example social networking sites (or social networking functions of the platform) of routes with other users (e.g. spouse, relatives, friends, etc). The routes shared can also come with various attributes such as the time of day traveled, time and distance of such route. There can also be a feedback and a rating mechanism by fellow users about the usefulness of such route and adding their qualitative comments or ratings. It is a way to socially share your route to your controlled set of users.

In another possible implementation, the platform may publish car pooling suggestions based for example on users who have similar routes and driving patterns through a matching engine linked to the platform. This aspect of the platform alone an result in very significant savings for users and for communities.

The platform can act as a means to provide feedback to the government on road issues; transportation issues, via voice or other means as user drive nearby such areas of concerns. The actual route and other statistics collected by the platform can also be shared with those stakeholders.

As shown in FIG. 3, the adaptive layer enables the derivation of pattern, trending and statistical information from the various items of information mentioned herein, which may be made part of the user's profile. In one aspect, the adaptive layer serves as the repository of all the data necessary to allow for the adaptive functions.

The platform may be operable to provide one or more utilities of reports to advertisers for example enabling to access served impression information, ‘click-through’ measurements, and various other advertising technology features. The platform may include, in one implementation, an advertising dashboard that enables advertiser customers of the operator of the platform to manage campaigns within the platform environment.

The platform may be leveraged to provide various data services to third parties such as for example municipalities to be able to review driver and traffic trends for example. These services may be consumed through a marketing dashboard for example.

Another use of this subsystem is to allow for an infrastructure owner to perform origination and destination analysis on certain trouble areas of the road, or for property developers to understand the route profile arriving at their retail locations.

The integration layer shown in FIG. 3 may include standard accounting, authentication, authorization and other such utilities, and a set of APIs to 3rd party applications to obtain personalized traffic information, as well as other information that is served by the platform such as location relevant messaging and advertisement.

This layer also serves the function of integrating 3rd party information or data sources necessary for the platform, such as for obtaining tomorrow's gas prices, weather, city events, road closure, parking availability, traffic incidents and police reports.

The integration layer also enables integration for example with third party ad serving systems with media partners.

Other location data collectors' data can be fed into the systems to enrich the platform's ability to detect traffic and also to get a better picture in real-time and via historical data within the context in which our user is found, via the integration layer. Some of these providers may include fleet management systems for trucks, taxis, police, etc, as well as other traffic detection instruments such as blue tooth device, flow meters, traffic cameras, etc.

In another aspect, the platform exposes a set of APIs for 3rd party applications to call. These applications can for example be a media partner's mobile application in which there is a feature to check personalized traffic.

The integration layer also enables the dissemination through the platform of various external events such as tomorrow's gas prices, city events, weather, parking availability, traffic incidents and police reports can be fed into the system to provide more utility for our user while driving.

### Ad Measurement and Ad Enhancement

In another implementation, as the user is listening to or viewing a traditional media advertisement served from the radio, TV, billboard, etc, the platform can synchronize and correlate such advertising based on time and location with the mobile application of the platform such that additional information and call to action can be presented at the same time, as a way to further interact with the ad (voice, touch or otherwise).

For example, when the user sees a billboard at a certain location, the mobile application can serve up additional content suggesting the users to response to get more product information, order a sample, or order the product or service right away from the mobile device. Another example would be a radio ad being served in the car while the user is driving. The mobile application can at the same time provide a way for the user to further interact with the ad to call in for more information.

This call to action from the mobile application is also traceable and can be correlated back to the traditional media ad improve effectiveness of campaigns.

This integration helps feed ad impressions and enables the delivery of marketing campaigns over new and valuable channels provided by the platform. The platform may also act as an analytical layer for traditional media and turn their one way (i.e. broadcasting) delivery into an interactive experience with accountable advertising measurements and tracking.

### Route Analytics

To measure the effectiveness of our marketing messages served on the platform, the platform enables analytics around the concept of “auto-checkin”.

For example, the platform allows the analysis of when a user has visited a particular location of interest. Using the location trajectory of our users, the platform determines if the users have been ‘visiting’ a particular location point of interest (POI) by looking at whether the users begin or end their trajectory near a POI of a certain distance, or if the users stop and stay within a certain distance of a POI before the users driven off to another location. This ‘auto-checkin’ functionality also allows the platform to serve up additional location specific content as you user reach near such POI.

The analytical engine is also capable of looking for a particular POI, and infer the approximate number of routes our user will be going through, and their origination and destination and route trajectory. This is of special interest to our ad sponsors, estate developers, and infrastructure owners

### Rich User Interaction Portal

In another possible aspect of the implementation of the present invention, a rich user interaction portal may be enabled by the platform, for example using a web presentment utility associated with the server application. The interaction portal may include for example a personalized view of all the trips and summary of intelligence the platform gathered from all the routes and interactions the user has had with the platform that the user may relevant. The goal of this portal is to go beyond the use case of interacting with the platform while driving, but also present the one or more features that users may access in non-driving scenarios. The content may be personalized to each user and also provide other insights on how other users having a similar profile use the platform. The interaction portal may provide insights such as the faster routes for particular start and end points. The objective of the portal is to allow users to review their personalized content and create opportunities to plan for future routes and explore possible features and configurations, and the advantages that these could provide. Obviously it is desirable that the user forego accessing such features when s/he is driving.

The platform may also implement one or more known features for minimizing the cost of wireless data transfer, for example one or more rules that may enable the user to select the transfer of the animated digital photos to remote computer only once the mobile device is connected to a preferred network meeting one or more parameters, for example a free WiFi network. These rules may be for example user defined, using one or more drop down menus or other mechanisms for selecting rules presented by a user interface associated with the settings facility (13), or may be obtained based on other user defined settings associated with other mobile applications of the user.

### Voice Search

In yet another implementation of the invention, a novel and innovative voice enabled search functionality is provided by the present invention. It enables a user to search for traffic information (as mentioned briefly above), so as to obtain for example flow/speed information, construction, accident, road maintenance incident reports, based on a travel path of interest to the user. The search functionality may be accessed solely by the user speaking to the mobile application a limited number of tags (as may be configured using the settings utility for example) such as for example (when the mobile application is in “listening mode”) the user stating one or more commands such as the name of the street and optionally the direction of the street, while the mobile application is listening and performing a speech to text conversion. In response the platform initiate a search of the ‘TrafficAlert’ database for possible relevant traffic information. The Traffic information is then presented back to the users via visual and audio alert.

A listening mode screen may be launched for example by touching a voice search button, snapping fingers, saying the name of the platform, or waving in front of the camera of the mobile device.

Once the mobile application gets the street name and possibly the direction of the street the user is interested in, it performs the speech to text conversion and then searches the traffic information of that street, including based on information collected or captured from other users. Once the traffic information is retrieved, it will then presented back to the users via an alert, which may be colour code for example based on associated traffic conditions. For example a “green” screen in response may indicate that there are no issues on that street in that direction.

Voice search may be used to access various other searchable feature of the present invention. The advantage of the invention is the rich real time information that is available, including based on the crowd sourced model.

The voice search feature can be implemented to incorporate various logical and semantic operations. For example, if the user is headed in an Easterly direction and indicates a particular street, the platform will assume that the user is interested in Easterly flow along the given path. The platform may use voice prompts to state its assumptions and provide access to a menu that is optimized based on the information that is available or inferable, including based on other users and the user's profile, as explained above. The platform may also include semantic maps for example to know that “DVP” in Toronto relates to “Don Valley Parkway”.

Various other applications are possible.

For example the mobile application may include one or more adapted graphical user interfaces. For example messages may be displayed in using the mobile application in way that enables them to be noticed, and enables interaction with content in a way that is easy and safe for drivers. For example, when messages are being displayed, the entire screen may turn automatically to a colour such as red. Also, the screens of the mobile application may be configured to enable a user to navigate between messages with a single touch, for example touching anywhere on the screen to access earlier messages or alerts. The mobile application may use a combination of voice and touch commands that are designed to minimize distraction of drivers.

### Different Possible Implementations

Depending on the particular implementation and various associated factors such as the resources of the mobile device, wireless network parameters, and requirements of the content distribution of social media platforms, different implementation architectures may be used for the present invention.

It should also be understood that the server (20) may be implemented as one or more servers in any possible server architecture or configuration including for example in a distributed server architecture, a server farm, or a cloud based computing environment.

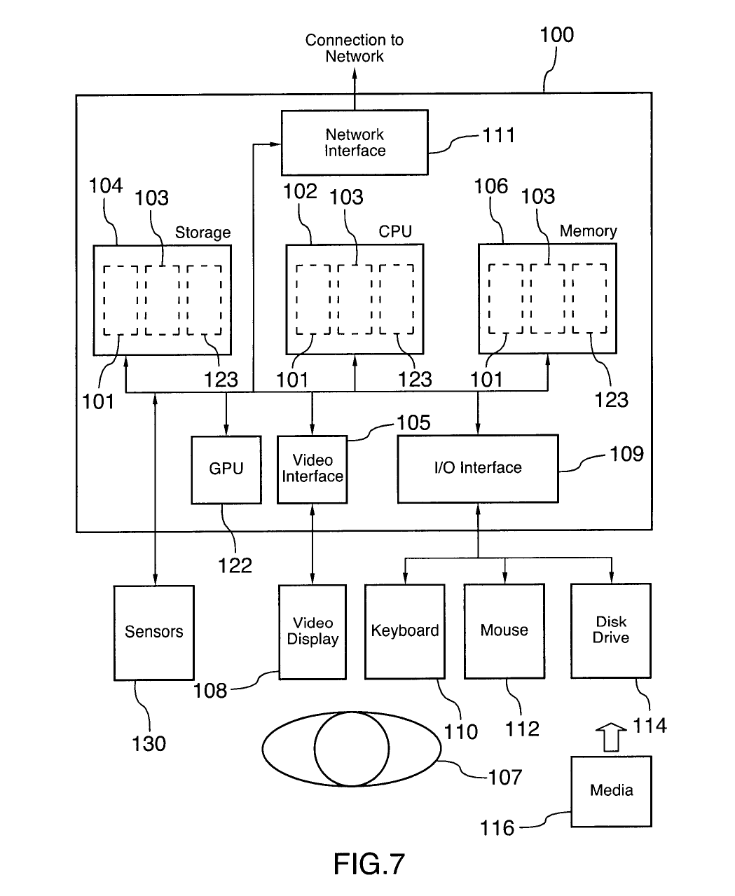

The present system and method may be practiced in various embodiments. A suitably configured computer device, and associated communications networks, devices, software and firmware may provide a platform for enabling one or more embodiments as described above. By way of example, FIG. 7 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The functionality described may be implemented to any mobile platform, including the iOS platform, ANDROID™, WINDOWS™ or BLACKBERRY™.

It will be appreciated by those skilled in the art that other variations of the embodiments described herein may also be practiced without departing from the scope of the invention. Other modifications are therefore possible.

### Advantages

Users only have a very limited attention span to safely view a display, image, screen or indicator on a mobile phone while driving, as they should be focusing on the actual road condition. Significantly, the present invention reduces the time it takes a user to digest traffic information in part because of the innovative features of the platform to filter only relevant content. The user does not need to mentally process and filter unimportant information, which is what is required with prior art platforms.

The platform of the present invention creates a highly desirable user experience by serving personalized, and often real-time, information, news and entertainment to users while they are in their cars.

The present platform may incorporate adaptive, targeted voice and multi-media based messaging, advertising and content delivery for brands and media companies to communicate and interact with the platform's users, in the context of a platform that provides significant value.

The platform is designed to provide a more relevant, safer, and just-in-time communication platform to the users by knowing the users' real-time context, such as but not limited to their locations, time of day, their current state of traffic condition around them, current weather, weather forecast, their driving route information, and other user profile information such as their user preferences and tastes, interaction preference, and interaction history with the platform, and other 3rd party source profiling such users.

The platform also derives additional relevant parameters and uses them to deliver this desirable user experience with insights from the user community, at the right time, right location and right context, by analysing the behaviour of all the users that have some association with the individual user receiving that personalized content (i.e. similar user profile).

Example of such associations are those users driving in the same direction or along the same street, or those users who have similar travel origination and destination, or those users who respond to an advertising message or news in a similar fashion, etc. These insights can also be in the form of additional content and information that is otherwise not know to the users, such as the quickest route from point A to point B.

The platform also adapts its messaging to the users based on how the users reacted to the previously delivered content, as well as the reactions of other users with similar user profiles within the same context.

The adaptive, voice-driven, context-aware capabilities of this platform enable far better user experience and utilities, and provide unobvious and new services that are otherwise not available.

The platform of the present invention may be understood as enabling users to arrive faster and more relaxed to their destination. By proving more accurate time to destination information, the platform helps users avoid being late for their meetings, but also to manage their time effectively. The platform improves productivity by reducing commute times and also encourages more efficient utilization of roads. This may result in infrastructure expense savings to government.

The platform may contribute to an engaging, interactive driving experience. Given the amount of time spent by people commuting, the functionality of the platform may be highly valued by consumers.

The platform may also deliver relevant news, information and entertainment during the drive.

In an implementation of the present invention, there is provided a method, performed by one of a mobile device and a computer server (which together may be referred to as the platform), the mobile device associated with a transportation vehicle and in communication with the computer server over a communications network, comprising: acquiring location information of the transportation vehicle; receiving current route information associated with the transportation vehicle; determining at least one route segment associated with the current route information; determining a travel direction of the transportation vehicle; determining a current route segment of the transportation vehicle from the determined at least one route segment associated with the current route information; updating a user profile with at least one information element based at least partly on the determined travel direction and the current route segment, the user profile associated with the transportation vehicle; filtering the at least one information element by performing at least one analytical operation on the user profile; and providing an indication of at least one of the filtered information elements at the mobile device.

Optionally, the filtering of the at least one information element may be based at least partly on a determined relevance of the at least one information element to an identified group of user profiles each associated with a transportation vehicle having determined to be at a similar location. Further optionally, the relevance may be determined in accordance with received solicited feedback associated with a respective one of the identified group of user profiles. In addition, the method may include generating the at least one information element based at least partly on the solicited feedback, the solicited feedback comprising at least one traffic condition, the at least one information element comprising traffic condition information.

Relevance may be further optionally determined at least partly in accordance with a comparison of the current route information with route information associated with the group of user profiles.

In an implementation, the user profile may be associated with a group of user profiles in accordance with at least one grouping criterion. The at least one information element may then be filtered by performing at least one analytical operation on the user profile group. The grouping criterion may include at least one current route segment commonly associated to each user profile in the group of user profiles.

In an implementation, the at least one analytical operation may comprise excluding at least one information element not located within a predetermined distance of any one of the at least one route segment associated with the current route information.

In an implementation, the at least one analytical operation may comprise excluding at least one information element not located in the determined travel direction.

In an implementation, the at least one information element may comprise traffic condition information associated with the travel direction and current route segment.

In an implementation, the current route information may be updated in accordance with a predicted route determination based at least partly on the user profile. Optionally, the predicted route determining may comprise comparing the current route information to previous route information associated with the user profile. Optionally still, the current route information may be updated in accordance with a predicted route determination based at least partly on the user profile group. In an implementation, the predicted route determining may comprise comparing the current route information to previous route information associated with the user profile group.

In an implementation, the analytical operation may comprise determining the relevance of a traffic incident report associated with a route segment. The indication of the at least one filtered information element may comprise a notification of the traffic incident report. Optionally, the traffic incident report relevance determination may comprise comparing the current route information with previous route information associated with the user profile. Optionally still, upon receiving the traffic incident report, at least one alternate route based at least partly on the current route information may be calculated avoiding the route segment associated with the traffic incident report. The at least one calculated alternate route may then be associated with the user profile. In response to a request at the mobile device for an alternate route, there may be provided an indication of the at least one calculated alternate route associated with the user profile at the mobile device. The traffic incident report relevance determination may be optionally based at least partly on a number of received instances of traffic incident reports comprising similar traffic incident information. In accordance with receiving a repeat request at the mobile device, there may be provided an indication of the traffic incident report notification again.

Optionally, the method may comprise associating each traffic incident report notification indicated at the mobile device and a respective notification time with the user profile. The method may further comprise in accordance with receiving a repeat request at the mobile device, providing an indication of at least one traffic incident report notification associated with the user profile again.

Optionally, the acquiring location information of the transportation vehicle comprises acquiring a plurality of GPS location samples over a predetermined time to determine a current roadway lane of travel.

Optionally, the filtered information element may comprise advertising information, and the indication of the filtered information element comprises an audio indication of the advertising information.

In an implementation, the filtered at least one information element may comprise a predicted destination corresponding to the at least one route segment associated with the current route information and the determined travel direction of the transportation vehicle; the indication may comprise a request for confirmation of the predicted destination; the method may further comprise updating the current route information in accordance with a confirmation received at the mobile device. Optionally, the request for confirmation may comprise an audio message played at the mobile device. The received confirmation may comprise a processed audio recording of a voice of an occupant of the transportation vehicle. Optionally still, the method may further comprise delaying providing indication of a subsequent request for confirmation at the mobile device in accordance with a measured voice inflection of the processed audio recording.

Optionally, the method may further comprise: in accordance with the received confirmation, determining at least one alternate route spanning from the current route segment to the confirmed predicted destination from a selection of alternate routes, each of the selection of alternate routes associated with at least one respective route quality attribute; associating the at least one alternate route with the user profile; and in response to a request at the mobile device for an alternate route, providing an indication of the at least one determined alternate route associated with the user profile at the mobile device.

Optionally, the current route information may comprise a destination. In this case, the method may further comprise: upon receiving an indication that the transportation vehicle has reached the destination, receiving an indication of at least one route quality attribute at the mobile device; associating the at least one received quality attribute with at least one of the at least one route segment determined to be associated with the current route information.

Optionally, the at least one received quality attribute may comprise an assessment of route capacity usage.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

What is claimed is:

1. A method, performed by one of a mobile device and a computer server, the mobile device associated with a transportation vehicle and in communication with the computer server over a communications network, comprising:
acquiring location information of the transportation vehicle;
receiving current route information associated with the transportation vehicle;
determining at least one route segment associated with the current route information;
determining a travel direction of the transportation vehicle;
determining a current route segment of the transportation vehicle from the determined at least one route segment associated with the current route information;
updating a user profile with at least one information element based at least partly on the determined travel direction and the current route segment, the user profile associated with the transportation vehicle;
filtering the at least one information element by performing at least one analytical operation on the user profile; and
providing an indication of at least one of the filtered information elements at the mobile device.

2. The method of claim 1 wherein the filtering of the at least one information element is based at least partly on a determined relevance of the at least one information element to an identified group of user profiles each associated with a transportation vehicle having determined to be at a similar location.

3. The method of claim 2 wherein the relevance is determined in accordance with received solicited feedback associated with a respective one of the identified group of user profiles.

4. The method of claim 3 comprising generating the at least one information element based at least partly on the solicited feedback, the solicited feedback comprising at least one traffic condition, the at least one information element comprising traffic condition information.

5. The method of any one of claims 2 to 4 wherein the relevance is determined at least partly in accordance with a comparison of the current route information with route information associated with the group of user profiles.

6. The method of claim 1 further comprising:
associating the user profile with a group of user profiles in accordance with at least one grouping criterion; and
filtering the at least one information element by performing at least one analytical operation on the user profile group.

7. The method of claim 6 wherein the grouping criterion comprises at least one current route segment commonly associated to each user profile in the group of user profiles.

8. The method of any one of claims 1 to 7 wherein the at least one analytical operation comprises excluding at least one information element not located within a predetermined distance of any one of the at least one route segment associated with the current route information.

9. The method of any one of claims 1 to 8 wherein the at least one analytical operation comprises excluding at least one information element not located in the determined travel direction.

10. The method of any one of claims 1 to 9 wherein the at least one information element comprises traffic condition information associated with the travel direction and current route segment.

11. The method of any one of claims 1 to 10 wherein the current route information is updated in accordance with a predicted route determination based at least partly on the user profile.

12. The method of claim 11 wherein the predicted route determining comprises comparing the current route information to previous route information associated with the user profile.

13. The method of any one of claims 6 to 7 wherein the current route information is updated in accordance with a predicted route determination based at least partly on the user profile group.

14. The method of claim 13 wherein the predicted route determining comprises comparing the current route information to previous route information associated with the user profile group.

15. The method of any one of claims 1 to 14 wherein the analytical operation comprises determining the relevance of a traffic incident report associated with a route segment, the indication of the at least one filtered information element comprising a notification of the traffic incident report.

16. The method of claim 15 wherein the traffic incident report relevance determination comprises comparing the current route information with previous route information associated with the user profile.

17. The method of any one of claims 15 to 16 comprising:
upon receiving the traffic incident report, calculating at least one alternate route based at least partly on the current route information avoiding the route segment associated with the traffic incident report;
associating the at least one calculated alternate route with the user profile; and
in response to a request at the mobile device for an alternate route, providing an indication of the at least one calculated alternate route associated with the user profile at the mobile device.

18. The method of any one of claims 15 to 17 wherein the traffic incident report relevance determination is based at least partly on a number of received instances of traffic incident reports comprising similar traffic incident information.

19. The method of any one of claims 15 to 18 comprising in accordance with receiving a repeat request at the mobile device, providing an indication of the traffic incident report notification again.

20. The method of any one of claims 15 to 18 comprising:
associating each traffic incident report notification indicated at the mobile device and a respective notification time with the user profile;
in accordance with receiving a repeat request at the mobile device, providing an indication of at least one traffic incident report notification associated with the user profile again.

21. The method of any one of claims 1 to 20 wherein acquiring location information of the transportation vehicle comprises acquiring a plurality of GPS location samples over a predetermined time to determine a current roadway lane of travel.

22. The method of any one of claims 1 to 21 wherein the filtered information element comprises advertising information, and the indication of the filtered information element comprises an audio indication of the advertising information.

23. The method of claim 1 wherein the filtered at least one information element comprises a predicted destination corresponding to the at least one route segment associated with the current route information and the determined travel direction of the transportation vehicle; the indication comprises a request for confirmation of the predicted destination; the method further comprising updating the current route information in accordance with a confirmation received at the mobile device.

24. The method of claim 23 wherein the request for confirmation comprises an audio message played at the mobile device, the received confirmation comprising a processed audio recording of a voice of an occupant of the transportation vehicle.

25. The method of claim 24 further comprising delaying providing indication of a subsequent request for confirmation at the mobile device in accordance with a measured voice inflection of the processed audio recording.

26. The method of any one of claims 23 to 25 comprising:
in accordance with the received confirmation, determining at least one alternate route spanning from the current route segment to the confirmed predicted destination from a selection of alternate routes, each of the selection of alternate routes associated with at least one respective route quality attribute;
associating the at least one alternate route with the user profile; and
in response to a request at the mobile device for an alternate route, providing an indication of the at least one determined alternate route associated with the user profile at the mobile device.

27. The method of claim 26 wherein the current route information comprises a destination, the method comprising:
upon receiving an indication that the transportation vehicle has reached the destination, receiving an indication of at least one route quality attribute at the mobile device;
associating the at least one received quality attribute with at least one of the at least one route segment determined to be associated with the current route information.

28. The method of claim 27 wherein the at least one received quality attribute comprises an assessment of route capacity usage.

29. A non-transitory computer program product tangibly embodying code that, when executed by a processor, causes the processor to carry out the method of any one of claims 1 to 28.

30. A system comprising a mobile device and a computer server, the mobile device associated with a transportation vehicle and in communication with the computer server over a communications network, one of the mobile device and the computer server being configured to:
acquire location information of the transportation vehicle;
receive current route information associated with the transportation vehicle;
determine at least one route segment associated with the current route information;
determine a travel direction of the transportation vehicle;
determine a current route segment of the transportation vehicle from the determined at least one route segment associated with the current route information;
update a user profile with at least one information element based at least partly on the determined travel direction and the current route segment, the user profile associated with the transportation vehicle;
filter the at least one information element by performing at least one analytical operation on the user profile; and
provide an indication of at least one of the filtered information elements at the mobile device.

31. The system of claim 30, wherein:
the analytical operation comprises determining the relevance of a traffic incident report associated with a route segment, the indication of the at least one filtered information element comprising a notification of the traffic incident report;
the traffic incident report relevance determination comprises comparing the current route information with previous route information associated with the user profile; and
the one of the mobile device and the computer server is further configured to:
upon receiving the traffic incident report, calculate at least one alternate route based at least partly on the current route information avoiding the route segment associated with the traffic incident report;
associate the at least one calculated alternate route with the user profile; and
in response to a request at the mobile device for an alternate route, provide an indication of the at least one calculated alternate route associated with the user profile at the mobile device.

32. The system of claim 30 wherein:
the filtered at least one information element comprises a predicted destination corresponding to the at least one route segment associated with the current route information and the determined travel direction of the transportation vehicle;
the indication comprises a request for confirmation of the predicted destination; and
the one of the mobile device and the computer server is further configured to update the current route information in accordance with a confirmation received at the mobile device.

33. The system of claim 32 wherein:
the request for confirmation comprises an audio message played at the mobile device; and
the received confirmation comprises a processed audio recording of a voice of an occupant of the transportation vehicle.

34. The system of any one of claims 32 to 33, the one of the mobile device and the computer server is further configured to:
in accordance with the received confirmation, determine at least one alternate route spanning from the current route segment to the confirmed predicted destination from a selection of alternate routes, each of the selection of alternate routes associated with at least one respective route quality attribute;
associate the at least one alternate route with the user profile; and
in response to a request at the mobile device for an alternate route, provide an indication of the at least one determined alternate route associated with the user profile at the mobile device.
